(19) United States
(12) Patent Application Publication
(10) Pub. No.: US 2026/0185334 A1
(43) Pub. Date: Jul. 2, 2026

(54) WATER CONDENSATION DEVICES HAVING SOLID-STATE CONDENSATION CORES

(71) Applicant: AIR2O TECHNOLOGIES, INC., Wilsonville, OR (US)

(72) Inventors: Farahmand ZIARI, Kennewick, WA (US); Mathew KENNEDY, Kennewick, WA (US); Garrett ALLEN, Sherwood, OR (US); Chase SHIMIZU, Portland, OR (US)

(21) Appl. No.: 19/433,329

(22) Filed: Dec. 26, 2025

Related U.S. Application Data
(60) Provisional application No. 63/739,338, filed on Dec. 27, 2024.

(51) Int. Cl. E03B 3/28; B01D 53/26; B01D 53/30

(52) U.S. Cl. CPC E03B 3/28; B01D 53/265; B01D 53/30; B01D 2257/80

(57) ABSTRACT

Water condensation devices in accordance with the present disclosure include a solid-state condensation core configured to induce condensation of water vapor from air in the surrounding environment. The solid-state condensation core includes a condensation member (e.g., a thermally conductive metal structure), a solid-state cooling device (e.g., a thermoelectric cooling module), and a heat sink (e.g., a fan). The solid-state cooling device is configured to reduce the surface temperature of the condensation member to induce condensation of water vapor on the surfaces of the condensation member and the heat sink is configured to dissipate the heat drawn away from the condensation member by the solid-state cooling device.

### CROSS-REFERENCES

The following applications and materials are incorporated herein by reference, in their entireties, for all purposes: U.S. Provisional Patent Application Ser. No. 63/739,338, filed Dec. 27, 2024.

### FIELD

This disclosure relates to novel systems and methods for generating water condensation, such as to generate potable water.

### INTRODUCTION

When air containing water vapor is cooled below its dew point temperature, excess water vapor in the air condenses into liquid water. This may occur when relatively warm air contacts a relatively cold surface, which cools the air below its dew point temperature.

### SUMMARY

The present disclosure provides systems, apparatuses, and methods relating to water condensation devices.

In some examples, a water condensation device includes: a condensation core, the condensation core including: a thermoelectric module comprising a cold surface and a hot surface, wherein the thermoelectric module is configured to actively transfer heat from the cold surface to the hot surface; a condensation member in contact with the cold surface, wherein the thermoelectric module is configured to reduce a surface temperature of the condensation member; and a heat sink operatively coupled to the hot surface and configured to dissipate heat from the hot surface.

In some examples, a method for generating water using a water condensation device comprises: reducing a surface temperature of a condensation member of the water condensation device utilizing a thermoelectric module; and causing air to pass over the condensation member.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram of an illustrative condensation core in accordance with aspects of the present disclosure.

FIG. 2 is a schematic diagram of an illustrative water condensation device in accordance with aspects of the present disclosure.

FIG. 3 is an isometric view of an illustrative example of the water condensation device of FIG. 2.

FIG. 4 is a sectional view of the illustrative water condensation device of FIG. 3 taken at line 3-3 in FIG. 3.

FIG. 5 is an isometric view of an illustrative condensation core of the water condensation device of FIGS. 2-4.

FIG. 6 is an isometric view of another illustrative condensation core in accordance with aspects of the present disclosure.

FIG. 7 is an isometric view of an illustrative condensation prism in accordance with aspects of the present disclosure.

FIG. 8 is a sectional view of four illustrative condensation prisms in accordance with aspects of the present disclosure.

FIG. 9 is an isometric view of another illustrative condensation prism in accordance with aspects of the present disclosure.

FIG. 10 is a sectional view of the illustrative condensation prism of FIG. 9.

FIG. 11 is an isometric view of another illustrative condensation prism in accordance with aspects of the present disclosure.

FIG. 12 is a sectional view of the illustrative condensation prism of FIG. 11.

FIG. 13 is an isometric view of another illustrative condensation prism in accordance with aspects of the present disclosure.

FIG. 14 is a sectional view of the illustrative condensation prism of FIG. 13.

FIG. 15 is an isometric view of an illustrative chevron condensation prism in accordance with aspects of the present disclosure.

FIG. 16 is a partially exploded view of the chevron condensation prism of FIG. 15.

FIG. 17 is an isometric view of another illustrative chevron condensation prism in accordance with aspects of the present disclosure.

FIG. 18 is a partially exploded view of another illustrative chevron condensation prism in accordance with aspects of the present disclosure.

FIG. 19 is a side view of the chevron condensation prism of FIG. 18.

FIG. 20 is an exploded view of another illustrative example of the water condensation device of FIG. 2 including a chevron condensation prism.

FIG. 21 is a sectional view of the water condensation device of FIG. 20.

FIG. 22 is a schematic diagram of another illustrative water condensation device in accordance with aspects of the present disclosure.

FIG. 23 is an isometric view illustrating an example of the water condensation device of FIG. 22.

FIG. 24 is an exploded view of the water condensation device of FIG. 23.

FIG. 25 is an isometric view of an illustrative heat-sink fan of the water condensation device of FIGS. 23-24.

FIG. 26 is a flow chart depicting steps of an illustrative method for producing water using a water condensation device according to the present teachings.

### DETAILED DESCRIPTION

Various aspects and examples of water condensation devices, as well as related methods, are described below and illustrated in the associated drawings. Unless otherwise specified, a water condensation device in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Coupled” means connected, either permanently or releasably, whether directly or indirectly through intervening components.

“Rigid” describes a material or structure configured to be stiff, non-deformable, or substantially lacking in flexibility under normal operating conditions.

“Processing logic” describes any suitable device(s) or hardware configured to process data by performing one or more logical and/or arithmetic operations (e.g., executing coded instructions). For example, processing logic may include one or more processors (e.g., central processing units (CPUs) and/or graphics processing units (GPUs)), microprocessors, clusters of processing cores, FPGAs (field-programmable gate arrays), artificial intelligence (AI) accelerators, digital signal processors (DSPs), and/or any other suitable combination of logic hardware.

A “controller” or “electronic controller” includes processing logic programmed with instructions to carry out a controlling function with respect to a control element. For example, an electronic controller may be configured to receive an input signal, compare the input signal to a selected control value or setpoint value, and determine an output signal to a control element (e.g., a motor or actuator) to provide corrective action based on the comparison. In another example, an electronic controller may be configured to interface between a host device (e.g., a desktop computer, a mainframe, etc.) and a peripheral device (e.g., a memory device, an input/output device, etc.) to control and/or monitor input and output signals to and from the peripheral device.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

### Overview

In general, water condensation devices in accordance with aspects of the present teachings are configured to produce liquid water by inducing condensation of water vapor from the air in a surrounding environment. The water condensation devices of the present disclosure comprise a solid-state condensation core including a solid-state cooling device (e.g., a thermoelectric cooling (TEC) module) configured to reduce a surface temperature of a condensation member of the solid-state condensation core. The water condensation device includes one or more mechanisms configured to cause air to flow over the cooled surfaces of the condensation member, e.g., an intake fan and/or a motor configured to rotate the condensation member itself, to facilitate condensation of water vapor on the cooled surfaces of the condensation member. The solid-state condensation core includes a heat sink that is coupled to the solid-state cooling device and the heat sink is configured to dissipate the heat that is drawn away from the condensation member by the solid-state cooling device.

### Examples, Components, and Alternatives

The following sections describe selected aspects of illustrative water condensation devices as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. Illustrative Solid-State Condensation Core

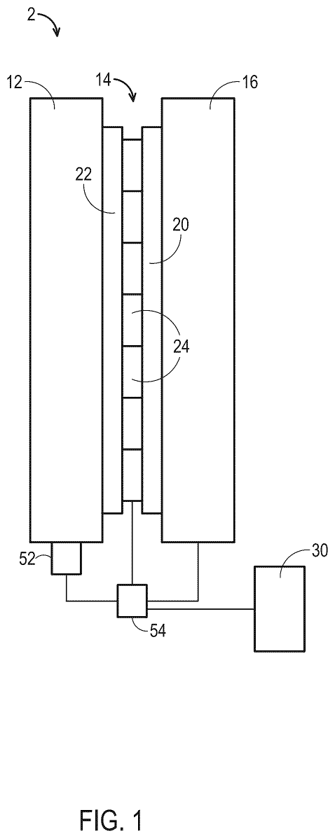

As shown in FIG. 1, this section describes an illustrative solid-state condensation core 2 configured to induce condensation of water vapor from air in a surrounding environment. Solid-state condensation core 2 is configured to be utilized in the water condensation devices discussed herein (e.g., water condensation devices 100 and 200 discussed below).

As shown in FIG. 1, solid-state condensation core 2 includes a solid-state cooling device 14 (e.g., a thermoelectric cooling module 114, 214 discussed below), a condensation member 12 (e.g., condensation member 112, 212 discussed below), and a heat sink 16 (e.g., heat sink 116, 216 discussed below). Solid-state condensation core 2 is configured to induce condensation of water vapor (e.g., from air in the surrounding environment) on the surfaces of condensation member 12 by reducing the surface temperature of condensation member 12. For example, solid-state cooling device 14 is configured to draw heat away from condensation member 12 to reduce the surface temperature of condensation member 12 and heat sink 16 is configured to dissipate the heat that is drawn away from condensation member 12 by solid-state cooling device 14.

Solid-state condensation core 2 may comprise any suitable cooling device(s) configured to reduce the surface temperature of condensation member 12 to a suitable temperature configured to induce condensation of water vapor on the surfaces of condensation member 12 (e.g., 0-degrees Celsius). In some examples, solid-state condensation core 2 includes a solid-state cooling device 14 that is configured to reduce the surface temperature of condensation member 12 without using liquids and/or gases as a heat transfer medium. For example, solid-state cooling device 14 may comprise a solid-state thermoelectric module (e.g., thermoelectric cooling module 114 and/or 214 discussed below) that is configured to utilize the Peltier effect to pump heat from a first side and/or surface (e.g., a cold side and/or surface) of the module to a second side and/or surface (e.g., a hot side and/or surface of the module). For example, solid-state cooling device 14 may comprise a thermoelectric cooling module including a hot surface 20 (AKA hot plate, hot side, etc.) and a cold surface 22 (AKA cold plate, cold side, etc.). In some examples, hot surface 20 and cold surface 22 are separated by a plurality of semiconductors 24 and/or any other suitable components configured to actively transfer and/or pump heat from cold surface 22 to hot surface 20. In some examples, semiconductors 24 comprise a plurality of alternating p-type and n-type semiconductors that are connected electrically in series with each other. When solid-state cooling device 14 is electrically connected to an electrical power supply 30 (e.g., a battery), a direct current (DC) electrical current flows through plurality of semiconductors 24 and a temperature difference is induced across the junctions between the alternating p-type and n-type semiconductors as a result of the Peltier effect. This causes heat to be actively transferred and/or pumped from cold surface 22 to hot surface 20 through plurality of semiconductors 24 as a result of the Peltier Effect.

Cold surface 22 may be operatively coupled to condensation member 12 and hot surface 20 may be operatively coupled to heat sink 16 to facilitate actively transferring and/or pumping heat from condensation member 12 to heat sink 16 through solid-state cooling device 14. For example, cold surface 22 may directly contact condensation member 12 and/or may be coupled to condensation member 12 in any other suitable manner permitting cold surface 22 to absorb heat from condensation member 12. Heat sink 16 may directly contact hot surface 20 and/or may be coupled to hot surface 20 in any suitable manner permitting heat sink 16 to absorb heat from hot surface 20 and dissipate the heat into a surrounding environment. Utilizing a solid-state cooling device 14 allows for precise surface temperature control of condensation member 12, reduced size and/or footprint of solid-state condensation core 2, reduced maintenance complexity of solid-state condensation core 2, and/or portability of the condensation devices that include solid-state condensation core 2.

Condensation member 12 may comprise any suitable structure(s) configured to be cooled by solid-state cooling device 14 to induce condensation of water vapor on the cooled surfaces of condensation member 12. For example, condensation member 12 may comprise any suitable thermally conductive structure(s) (e.g., an aluminum structure) configured to have its surface temperature reduced through contact with cold surface 22 of solid-state cooling device 14. Condensation member 12 may comprise a thermally conductive metal and/or metal alloy (e.g., copper, silver, magnesium, aluminum, titanium, stainless steel, brass, bronze, etc.), a thermally conductive non-metal and/or composite material (e.g., graphite, graphene, carbon fiber composites, etc.), a thermally conductive ceramic material, and/or any other suitable material having suitable thermal conductivity to permit solid-state cooling device 14 to reduce the surface temperature of condensation member 12, e.g., through direct contact with cold surface 122. In some examples, condensation member 12 comprises a thermally conductive plate (e.g., metal plate 232 discussed below) having any suitable, shape, size, and/or thickness. For example, condensation member 12 may comprise a metal plate comprising aluminum and/or any other suitable thermally conductive material configured to have its surface temperature reduced through contact with cold surface 22 of solid-state cooling device 14.

As discussed below, in some examples, condensation member 12 comprises a condensation prism (e.g., one of condensation prisms 132 discussed below) that includes and/or defines an airflow pathway through which air is caused to flow (e.g., using an air intake fan 104). The condensation prism is configured to have its surface temperature reduced by solid-state cooling device 14 and is configured to induce condensation of water vapor on the cooled surfaces of the condensation prism within the airflow pathway. In some examples, the condensation prism includes a plurality of deflection structures obstructing the airflow pathway to form and/or define a tortuous airflow pathway through the condensation prism. The tortuous airflow pathway is configured to increase contact between the air and the cooled surfaces of the condensation prism resulting in improved water condensation.

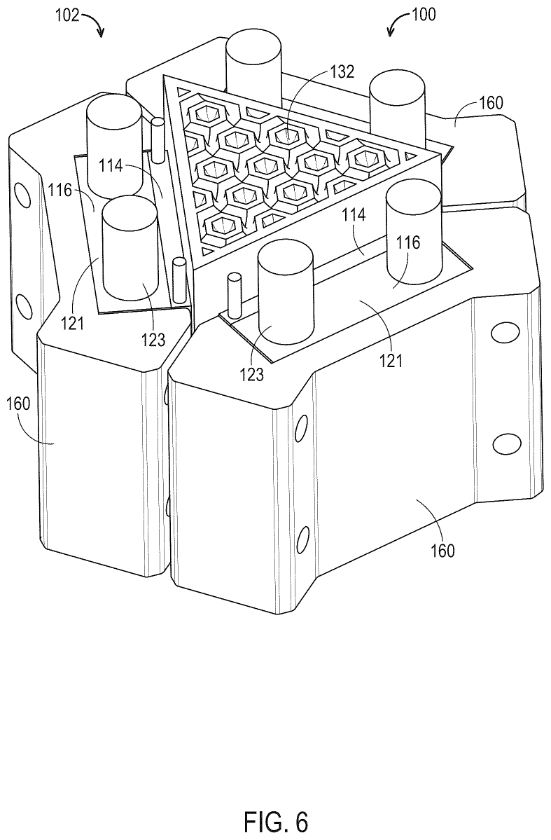

Solid-state condensation core 2 may have any suitable heat sink(s) 16 configured to dissipate heat from solid-state condensation core 2. For example, heat sink(s) 16 may be operatively coupled to hot surface 20 of solid-state cooling device 14, such that heat sink(s) 16 are configured to dissipate the heat that is drawn away from condensation member 12 by solid-state cooling device 14. Condensation core 2 may comprise passive, active, and/or hybrid heat sink(s) 16. For example, heat sink(s) 16 may include a fan (e.g., fan 117, 217 discussed below) and/or a pump that is configured to actively dissipate the heat away from solid-state condensation core 2 into the surrounding environment. In some examples, as shown in FIG. 6 discussed below, heat sink(s) 16 may comprise a water-cooling block comprising a thermally conductive structure (e.g., aluminum or copper) in contact with hot surface 20 and having one or more internal fluid lines that are configured to receive a cooled liquid to facilitate absorbing heat from hot plate. In some examples, heat sink(s) 16 may comprise a passive heat sink 16, such as any suitable thermally conductive structures (e.g., aluminum structures), configured to absorb heat from hot surface 20 and transfer the heat into air in the surrounding environment without using any fans, pumps, and/or cooled liquids or gases.

Condensation core 2 may have any suitable number and/or arrangement of condensation member(s) 12, solid-state cooling device(s) 14, and/or heat sink(s) 16. In some examples, multiple solid-state cooling device(s) 14 may be utilized to cool the surface of a condensation member 12 and a respective heat sink 16 may be coupled to each of the multiple solid-state cooling device(s) 14.

Solid-state condensation core 2 may incorporate any suitable condensation member(s) 12, solid-state cooling device(s) 14 (e.g., thermoelectric modules), and/or heat sink(s) 16 having any suitable properties in order to improve energy efficiency (e.g., energy usage compared to water produced), water production, manufacturing costs, size, noise, and/or based on any other suitable operational considerations of condensation core 2. In some examples, specific condensation member(s) 12, solid-state cooling device(s) 14, and/or heat sink(s) 16 may be utilized dependent on the expected environmental conditions and/or based on the other components of the solid-state condensation core 2 being utilized. For example, specific condensation member(s) 12 may be more efficient when utilized with specific solid-state cooling device(s) 14 and/or when utilized in specific environmental conditions (e.g., high humidity environments or low humidity environments). The components of solid-state condensation core 2 may be selected to address specific operational considerations and/or specific environmental conditions.

In some examples, solid-state condensation core 2 may include solid-state cooling device(s) 14 having specific properties based on the expected environmental conditions in which solid-state condensation core 2 is intended to be utilized, based on the heat-dissipation capacity of heat sink(s) 16, and/or based on the specific condensation member(s) 12 being utilized. For example, in a high humidity environment, a thermoelectric cooling module having greater electrical power (e.g., a lower electrical resistance and greater electrical current draw) may be more efficient than a thermoelectric cooling module having a higher electrical resistance. In a dry environment having a relatively low humidity, a thermoelectric cooling module having greater electrical resistance may be more efficient than a thermoelectric cooling module having greater electrical power. Additionally, thermoelectric cooling modules having greater electrical power may be more efficient when utilized with heat sink(s) 16 having greater heat dissipation capacity, whereas thermoelectric cooling modules having higher electrical resistance may be more efficient when utilized with heat sink(s) 16 having a relatively low heat dissipation capacity. Different heat sink(s) 16 having different heat dissipation capacities may be utilized dependent on the desired size, cost, noise, heat dissipation capacity, etc., of condensation core 2.

For example, in a high humidity environment and/or when used with heat sink(s) 16 having a relatively high heat dissipation capacity, a thermoelectric cooling module having a relatively high power (e.g., 200 W) may be utilized to improve the water production efficiency of condensation core 2. In a low humidity environment and/or when used with heat sink(s) having a relatively low heat dissipation capacity, a thermoelectric cooling module having a relatively high resistance (e.g., 2.5 Ohms) may be utilized to improve the water production efficiency of condensation core 2. The above examples are non-limiting and any suitable solid-state cooling devices 14 having any suitable properties (e.g., electrical powers, resistances, etc.) may be utilized in solid-state condensation core 2.

In some examples, solid-state condensation core 2 includes an electrical power supply 30 configured to supply electrical power to the electrical components of solid-state condensation core 2 including solid-state cooling device 14, heat sink(s) 16, and/or sensor(s) 52. Electrical power supply 30 may comprise one or more batteries, generators, fuel cells, supercapacitors, photovoltaic cells or solar panels, and/or any other suitable devices configured to provide electrical power. In some examples, the electrical power supply includes one or more batteries, which may be rechargeable batteries and/or single-use batteries. In some examples, solid-state condensation core 2 includes one or more rechargeable batteries configured to be recharged using solar energy, e.g., via one or more solar panels.

In some examples, solid-state condensation core 2 includes a control system including one or more electronic controllers 54 that are configured to selectively control the electrical components of solid-state condensation core 2, e.g., by regulating the electrical power supplied to the electrical components by the electrical power supply 30. For example, electronic controller(s) 54 may be configured to regulate the electrical power supplied to solid-state cooling device 14 in order to regulate the surface temperature of condensation member 12. For example, increasing the electrical power supplied to solid-state cooling device 14 may increase the active transferring of heat from cold surface 22 to hot surface 20 by solid-state cooling device 14, which decreases the temperature of cold surface 22. In such examples, cold surface 22 is thermally coupled to (e.g., in direct contact with) condensation member 12, such that decreasing the temperature of cold surface 22 decreases the temperature of condensation member 12.

Additionally, and/or alternatively, the surface temperature of condensation member 12 may be regulated by causing air to flow over the cooled surfaces of condensation member 12 and/or by controlling heat dissipation by heat sink(s) 16. For example, solid-state condensation core 2 may be integrated into a water condensation device including an air intake fan, e.g., water condensation device 100 having air intake fan 104 discussed below. In such examples, the air intake fan is configured to force air from the surrounding environment to pass over the surfaces of condensation member 12 and the surface temperature of condensation member 12 may be controlled by increasing or decreasing the fan speed of the intake fan. For example, increasing air flow over the surfaces of condensation member 12 may increase the surface temperature of condensation member 12 and decreasing air flow over the surfaces of condensation member 12 may decrease the surface temperature of condensation member 12. In some examples, heat sink(s) 16 are selectively controlled to increase and/or decrease the surface temperature of condensation member 12. For example, heat sink(s) 16 may comprise a fan and increasing a fan speed of heat sink(s) 16 may increase heat dissipation by heat sink(s) 16, which decreases the surface temperature of condensation member 12. The air intake fan and/or heat sink(s) 16 may be selectively controlled by the one or more electronic controller(s) 54 of solid-state condensation core 2.

In some examples, solid-state condensation core 2 comprises one or more sensors 52 (e.g., temperature sensors, humidity sensors, etc.) configured to detect the temperature of condensation member 12, the temperature of cold surface 22, the temperature of the surrounding environment, the relative humidity and/or dew point of the surrounding environment, and/or any other suitable data relating to the condition of one or more component(s) of solid-state condensation core 2 and/or the surrounding environment. In some examples, electronic controller(s) 54 include processing logic configured to selectively control the electrical components of condensation core 2 to regulate the surface temperature of condensation member 12 based on the data detected by sensor(s) 52. For example, controller(s) 54 may be configured to selectively control solid-state cooling device 14, heat sink(s) 16, and/or an air intake fan in order to maintain condensation member 12 at a desired temperature.

In some examples, processing logic of the electronic controller(s) 54 is configured to determine the desired temperature of condensation member 12 based on one or more environmental condition(s) detected by sensor(s) 52 (e.g., relative humidity, dew point, air temperature, etc.) and/or based on the operating conditions (e.g., temperature) and/or specific characteristics of the components of condensation core 2. For example, the desired temperature of condensation member 12 may be set at or below the detected and/or calculated ambient dew point temperature. Alternatively, in some examples, the control system is configured to maintain condensation member 12 at any suitable predetermined surface temperature (e.g., 0-degrees Celsius).

In some examples, as discussed below, the control system is configured to balance the ideal surface temperature of condensation member 12 for inducing condensation with the heat pumping efficiency of solid-state cooling device 14. Explained in other words, the control system may be configured to attempt to maximize and/or improve the amount of water produced by condensation core 2 per amount of energy used. For example, solid-state cooling device 14 may operate more efficiently (e.g., pump more heat for a given input electrical power) when the temperature difference between cold surface 22 and hot surface 20 is lesser and less efficiently (e.g., pump less heat for the given input electrical power) when the temperature difference is greater. As a result, attempting to reduce the surface temperature of condensation member 12 below a certain temperature, e.g., by continuing to increase the electrical power supplied to solid-state cooling device 14, may reduce the operational efficiency of solid-state cooling device 14 and therefore the water production efficiency of condensation core 2. The specific input electrical power at which the heat pumping efficiency of solid-state cooling device 14 diminishes may depend on the characteristics of the specific solid-state cooling device 14 being utilized, e.g., the electrical resistance, maximum current, maximum voltage, thermal conductance, cooling capacity, maximum temperature differential between cold surface 22 and hot surface 20, etc., of solid-state cooling device 14.

Additionally, increasing airflow over the surfaces of condensation member 12 increases the amount of water vapor that contacts and/or is cooled by condensation member 12, but simultaneously increases the surface temperature of condensation member 12, which decreases the cooling effect of condensation member 12. In some examples, the control system (e.g., controller(s) 54) of condensation core 2 is configured to dynamically balance the electrical power provided to solid-state cooling device 14, the airflow rate of air passing over the surfaces of condensation member 12 (e.g., by controlling an intake fan speed and/or a speed at which condensation core 2 itself is rotated), and/or the amount of heat being dissipated by heat sink(s) 16 to maximize and/or improve the amount of water produced by condensation core 2 per amount of energy used.

In some examples, the control system may include processing logic that is configured to estimate the current water production by condensation core 2 based on the ambient environmental conditions (e.g., temperature, relative humidity, dew point, etc.) and/or a measured temperature of one or more components of condensation core 2 (e.g., the temperature of condensation member 112 and/or cold surface 122) detected by sensor(s) 52. In such examples, the control system may be configured to incrementally adjust the airflow rate (e.g., using an intake fan) and/or incrementally adjust the electrical power supplied to solid-state cooling device 14. After making the incremental adjustment, the control system recalculates the estimated water production by condensation core 2 based on updated measurements of the ambient environmental conditions and/or the temperature of condensation core 2 detected by sensor(s) 52. If the predicted water production increases based on the updated measurements, the control system continues to incrementally adjust the airflow rate and/or the electrical power supplied to solid-state cooling device 14 in the same direction, e.g., continues to increase or decrease the airflow rate and/or the electrical power. If the predicted water production decreases based on the updated measurements, the control system reverses or modifies the incremental adjustment. In this manner, the control system is configured to actively and incrementally increase water production by condensation core 2, during use.

Alternatively, and/or additionally, in some examples, the control system includes processing logic that is configured to calculate an input electrical power to solid-state cooling device 14 and/or an airflow rate that theoretically maximizes the operational efficiency of condensation core 2. For example, based on the ambient environmental conditions (e.g., air temperature, dew point, relative humidity, etc.) and/or the specific characteristics of solid-state cooling device 14 (e.g., electrical resistance, cooling capacity, etc.), the control system is configured to calculate the theoretical electrical power and/or airflow rate that maximizes the amount of heat that is pumped by solid-state cooling device 14 per energy input. The control system then operates condensation core 2 according to the calculated theoretical electrical power and/or airflow rate. In some such examples, the control system is configured to automatically adjust the calculated theoretical electrical power and/or airflow rate based on actual measured data detected by sensor(s) 52.

As discussed above, in some examples, the control system of condensation core 2 is configured to dynamically control the electrical power provided to solid-state cooling device 14 and/or the airflow rate of air passing over condensation core 2 to maintain condensation core 2 at a temperature that promotes water condensation, without exceeding the point where additional power input and/or additional airflow results in diminished cooling performance of solid-state cooling device 14. As such, the control system is configured to improve and/or attempt to maximize the amount of water produced and/or collected by condensation core 2 per amount of energy used.

In some examples, condensation core 2 includes multiple operational modes. In some examples, the different operational modes of condensation core 2 dictate how often and/or under what environmental conditions condensation core 2 is activated to produce water. For example, condensation core 2 may have a first operational mode in which condensation core 2 is only activated in response to detecting a specific environmental condition, e.g., a specific relative humidity, a specific dew point. In such examples, controller(s) 54 may only control the electrical components of condensation core 2 to reduce the surface temperature of condensation member 12 in response to sensor(s) 52 detecting that the relative humidity and/or dew point in the surrounding environment reaches a threshold level. The threshold level may be set at any suitable value. For example, the threshold level may be set at an optimal level, such that condensation core 2 is only activated when the relative humidity and/or dew point are such that condensation core 2 is able to efficiently produce a large amount of water. Additionally, and/or alternatively, the threshold level may be set, such that condensation core 2 is automatically activated when the environmental conditions permit collecting any substantial amount of water. In some examples, condensation core 2 may include an operational mode in which condensation core 2 is continuously activated to continuously attempt to induce water condensation on the surfaces of condensation member 12 regardless of the environmental conditions.

As discussed further below, condensation core 2 may be integrated into a plurality of water condensation devices. For example, water condensation devices 100 and 200 discussed below each include a respective example of condensation core 2 schematically shown and described with reference to FIG. 1. In some examples, the control system discussed above may be incorporated into the water condensation devices (e.g., water condensation devices 100 and/or 200) discussed below in order to improve the water production efficiency of the water condensation devices.

### B. First Illustrative Water Condensation Device

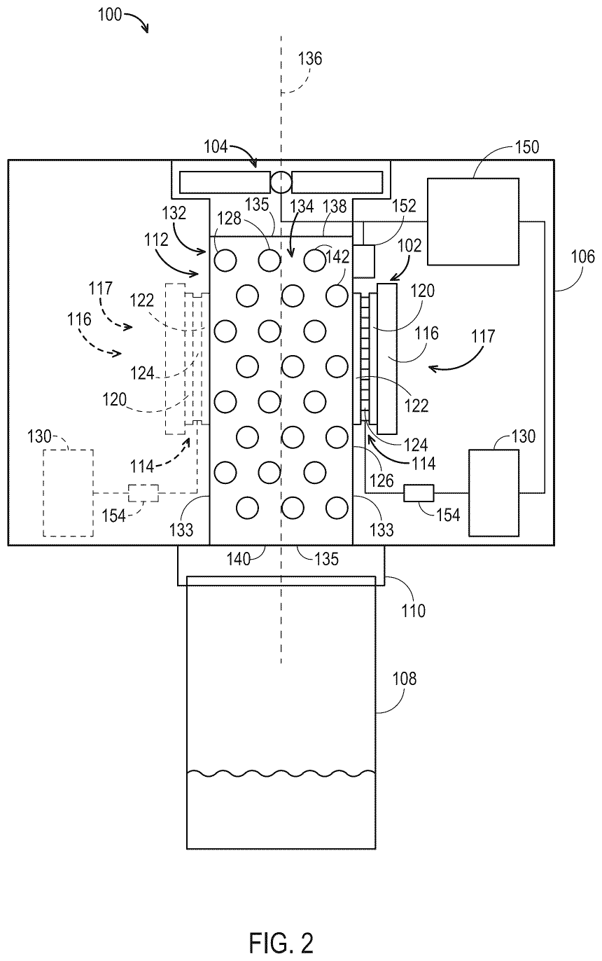

As shown in FIGS. 2-12, this section describes an illustrative water condensation device 100. Water condensation device 100 is an example of the water condensation devices described above in the Overview.

FIG. 2 schematically illustrates a water condensation device 100. As shown in FIG. 2, water condensation device 100 includes a condensation core 102, an intake fan 104 and/or any other suitable air-moving device, and a housing 106 that supports condensation core 102 and intake fan 104. Intake fan 104 is configured to draw in air from the environment surrounding housing 106. Condensation core 102 is configured to reduce the temperature of the air that is drawn in by intake fan 104 and induce condensation of water vapor in the air. Condensation core 102 is an example of condensation core 2 discussed above with reference to FIG. 1. In some examples, water condensation device 100 is sized to be easily portable for a user.

In some examples, water condensation device 100 is configured to be connected to a water receiver 108 (e.g., a water bottle), such that the liquid water that is produced by the device may be collected for use. For example, housing 106 may comprise a water-receiver connector 110 (e.g., a threaded connector) that is configured to couple to water receiver 108. In some examples, water-receiver connector 110 is disposed on the bottom side of housing 106, such that water receiver 108 is configured to be connected below housing 106 during use. This may facilitate using gravity to force condensed water to fall from water condensation device 100 into water receiver 108.

As shown in FIG. 2, condensation core 102 comprises a condensation member 112, one or more thermoelectric cooling (TEC) modules 114 (AKA thermoelectric modules), and one or more heat sinks 116. Thermoelectric cooling module 114 is configured to draw heat away from condensation member 112 and heat sink 116 is configured to dissipate the heat that is drawn away from condensation member 112 by thermoelectric cooling module 114. Thermoelectric cooling module 114 is configured to reduce a surface temperature of one or more condensation surfaces 128 of condensation member 112. The cooled condensation surfaces 128 of condensation member 112 are configured to reduce the temperature of the air that contacts the surfaces and induce condensation of water vapor on condensation surfaces 128. For example, intake fan 104 may be configured to draw in air from the surrounding environment and force the air to contact condensation surfaces 128 of condensation member 112.

Water condensation device 100 may include any suitable solid-state cooling device configured to reduce the surface temperature of condensation member 112. In some examples, the solid-state cooling device of water condensation device 100 is configured to reduce the surface temperature of condensation member 112 without the use of liquids, gases, and/or moving parts. In some examples, the solid-state cooling device comprises a thermoelectric cooling module 114 and/or any suitable thermoelectric device that is configured to reduce the surface temperature of condensation member 112 using the Peltier effect. For example, thermoelectric cooling module 114 may include a hot plate 120 (AKA hot surface) and a cold plate 122 (AKA cold surface) separated by a plurality of semiconductors 124. In some examples, plurality of semiconductors 124 may comprise a plurality of alternating p-type and n-type semiconductors that are connected electrically in series with each other. When thermoelectric cooling module 114 is electrically connected to an electrical power supply (e.g., a battery 130), a direct current (DC) electrical current flows through plurality of semiconductors 124 and a temperature difference is induced across the junctions between the alternating p-type and n-type semiconductors as a result of the Peltier effect. This causes heat to be actively transferred and/or pumped from cold plate 122 to hot plate 120 through plurality of semiconductors 124.

Cold plate 122 is coupled to (e.g., in direct contact with) condensation member 112 and hot plate 120 is coupled to heat sink 116. For example, thermoelectric cooling module 114 may be sandwiched between condensation member 112 and heat sink 116 with cold plate 122 operatively coupled to condensation member 112 and hot plate 120 operatively coupled to heat sink 116. Cold plate 122 may be coupled to condensation member 112 in any suitable manner configured to permit cold plate 122 to absorb heat from condensation member 112 and/or reduce the surface temperature of condensation member 112. For example, a surface of cold plate 122 may directly contact the surface of condensation member 112. As discussed above, cold plate 122 is configured to actively transfer and/or pump heat from cold plate 122 to hot plate 120. Heat sink 116 is operatively coupled to hot plate 120 in any suitable manner configured to permit heat sink 116 to absorb heat from hot plate 120 and dissipate the heat away from hot plate 120 into the surround environment.

Cold plate 122 (AKA cold surface) and hot plate 120 (AKA hot surface) may each comprise any suitable thermally conductive plates that are configured to facilitate transferring heat between condensation member 112 and heat sink 116. For example, cold plate 122 and hot plate 120 may each comprise a ceramic material. In some examples, cold plate 122 and hot plate 120 each comprise a planar surface that is configured to contact condensation member 112 and/or heat sink 116, respectively.

Heat sink 116 may comprise any suitable structure(s) configured to absorb heat from hot plate 120 and/or dissipate the heat into air in the environment surrounding water condensation device 100. Heat sink 116 may be in direct contact with hot plate 120 to facilitate absorbing heat from hot plate 120. In some examples, heat sink 116 may comprise a fan 117 that is configured to dissipate the heat away from water condensation device 100 into the surrounding environment. Alternatively, or additionally, in some examples, heat sink 116 may comprise any suitable water-cooling block comprising a thermally conductive structure (e.g., aluminum or copper) in contact with hot plate 120 and having one or more internal fluid lines that are configured to receive a cooled liquid to facilitate absorbing heat from hot plate 120.

Condensation core 102 may have any suitable number and/or arrangement of condensation member(s) 112, thermoelectric cooling module(s) 114, and/or heat sink(s) 116 dependent on the size, shape, and/or desired surface temperature of condensation member 112. For example, condensation core 102 may include multiple thermoelectric cooling modules 114 (e.g., two thermoelectric cooling modules 114) each having a respective cold plate 122 contacting a condensation member 112 and a respective hot plate 120 coupled to a respective heat sink 116. As shown in FIG. 2, in some examples, condensation member 112 is sandwiched between the multiple different thermoelectric cooling modules 114, such that condensation member 112 is contacted by cold plate 122 of each thermoelectric cooling module 114. Condensation core 102 may have a respective heat sink 116 connected to hot plate 120 of each thermoelectric cooling module 114.

Condensation member 112 is configured to be cooled by thermoelectric cooling module 114 to facilitate inducing condensation of water vapor on the cooled surfaces of condensation member 112. In some examples, condensation member 112 comprises at least one cooling surface 126 in contact with cold plate 122 of thermoelectric cooling module 114. Cooling surface 126 may comprise a planar cooling surface in contact with cold plate 122. Cold plate 122 is configured to reduce a surface temperature of condensation member 112 through contact with cooling surface 126. For example, condensation member 112 may comprise any suitable thermally conductive material, e.g., aluminum, that is configured to permit heat to move through condensation member 112 to be absorbed by cold plate 122. The thermally conductive material facilitates cold plate 122 reducing the surface temperature of an entirety of condensation member 112 through contact with cooling surface 126 of condensation member 112.

Water condensation device 100 may include any suitable air-moving device (e.g., intake fan 104) that is configured to intake air (e.g., from the surrounding environment) and cause the air to pass over the surfaces of condensation member 112 to induce condensation of water vapor on the surfaces. In some examples, water condensation device 100 includes an intake fan 104 including blades and/or any other suitable structures that are configured to be rotated to move air against the surfaces of condensation member 112. Alternatively, and/or additionally, water condensation device 100 may include one or more pumps, compressors, blowers, and/or any other suitable air-moving device(s) configured to cause air to pass over the surfaces of condensation member 112.

In some examples, water condensation device 100 includes an electrical power supply, e.g., one or more batteries 130, configured to supply electrical power to the electrical components of water condensation device 100 including thermoelectric cooling module(s) 114, heat sink(s) 116, intake fan 104, etc. For example, water condensation device 100 may include one or more batteries 130, generators, fuel cells, supercapacitors, photovoltaic cells or solar panels, and/or any other suitable devices configured to supply electrical power. In some examples, the electrical power supply includes one or more batteries 130, which may be rechargeable batteries and/or single-use batteries.

In some examples, water condensation device 100 includes a control system including one or more electronic controllers (e.g., TEC controllers 154 and/or fan controller 150) that are configured to selectively control the electrical components of water condensation device 100. For example, water condensation device 100 may include one or more TEC controllers 154 (AKA thermoelectric-module controllers) configured to regulate the electrical power supplied to TEC module(s) 114 in order to regulate the surface temperature of condensation member 112. For example, increasing the electrical power supplied to TEC module(s) 114 may increase the transfer of heat from cold plate 122 to hot plate 120 and therefore decrease the temperature of cold plate 122. Cold plate 122 is thermally coupled to (e.g., in direct contact with) condensation member 112, such that decreasing the temperature of cold plate 122 decreases the temperature of condensation member 112.

In some examples, water condensation device 100 comprises a fan controller 150 operatively coupled to intake fan 104. Fan controller 150 is configured to selectively regulate a fan speed of intake fan 104. Fan controller 150 may comprise any suitable device having processing logic that is configured to receive and analyze one or more input values and determine one or more corresponding control operations for controlling the fan speed of intake fan 104. Fan controller 150 and intake fan 104 may be electrically connected to and powered by any suitable electric power supply (e.g., a battery 130).

In some examples, fan controller 150 is configured to selectively regulate the fan speed of intake fan 104 to control the surface temperature of condensation member 112. For example, increasing the fan speed of intake fan 104 causes more air and air moving at a faster speed to contact condensation member 112, which increases the surface temperature of condensation member 112. Likewise, decreasing the fan speed of intake fan 104 may decrease the surface temperature of condensation member 112.

In some examples, fan controller 150 is configured to selectively regulate the fan speed and/or TEC controller(s) 154 are configured to selectively control TEC module(s) 114 in order to maintain the surface temperature of condensation member 112 at a desired surface temperature. The surface temperature of condensation member 112 may be regulated by only controlling intake fan 104, only controlling TEC module(s) 114, or the surface temperature may be controlled by controlling both the fan speed of intake fan 104 and the amount of heat pumped by TEC module(s) 114. In some examples, fan controller 150 and TEC controller(s) 154 comprise a single electronic controller configured to control both intake fan 104 and TEC module(s) 114. Alternatively, fan controller 150 and TEC controller(s) 154 may comprise separate electronic controllers.

The control system of water condensation device 100 including fan controller 150 and/or TEC controller(s) 154 may be configured to cool condensation member 112 to any suitable surface temperature and/or maintain condensation member 112 at any suitable surface temperature configured to promote condensation of water vapor on the surfaces of condensation member 112. In some examples, processing logic of the control system is configured to dynamically determine the surface temperature at which to maintain condensation member 112 based on the ambient environmental conditions (e.g., relative humidity, dew point temperature, air temperature, etc.) and/or operational conditions (e.g., temperature) of one or more of the components of condensation core 102 detected by one or more sensor(s) 152 of water condensation device 100. For example, the surface temperature of condensation member 112 may be set at or below the ambient dew point temperature. Alternatively, in some examples, fan controller 150 and/or TEC controller(s) 154 may be configured to cool and maintain condensation member 112 at a predetermined set point temperature, e.g., approximately 0 degrees Celsius.

Water condensation device 100 may comprise any suitable sensors 152 (e.g., temperature sensors, humidity sensors, etc.) configured to detect the temperature of condensation member 112, the temperature of cold plate 122, the temperature of the surrounding environment, the relative humidity and/or dew point of the surrounding environment, and/or any other suitable data relating to the condition of one or more component(s) of solid-state condensation core 102 and/or the surrounding environment. For example, sensor(s) 152 may include an RTC thermistor and/or any other suitable temperature sensor(s) configured to detect the temperature of condensation member 112 and/or cold plate 122 of thermoelectric cooling module 114.

In some examples, the control system includes processing logic configured to selectively control the electrical components of condensation core 102 to regulate the surface temperature of condensation member 112 based at least in part on the data detected by sensor(s) 152. For example, processing logic of the control system may be configured to determine the desired temperature of condensation member 112 based at least in part on one or more environmental condition(s) detected by sensor(s) 52, (e.g., relative humidity, dew point, air temperature, etc.), the temperature of one or more components of condensation core 102 detected by sensors 152, and/or based on the specific characteristics of TEC module(s) 114.

In some examples, TEC controller(s) 154 and/or fan controller 150 may be configured to monitor the temperature of condensation member 112 and/or cold plate 122 of thermoelectric cooling module 114 and selectively regulate the fan speed and/or the temperature of cold plate 122 based on the detected temperature. For example, in response to the detected temperature being greater than the desired temperature, fan controller 150 may be configured to reduce the fan speed of intake fan 104 and/or TEC controller(s) 154 may be configured to reduce the temperature of cold plate 122 in order to reduce the temperature of condensation member 112. In response to the detected temperature being less than the desired temperature, fan controller 150 may be configured to increase the fan speed of intake fan 104 and/or TEC controller(s) 154 may be configured to increase the temperature of cold plate 122 to increase the temperature of condensation member 112.

In some examples, fan controller 150 is configured to increase or decrease the fan speed by a corresponding amount dependent on the deviation between the detected surface temperature and the desired temperature. For example, fan controller 150 may be configured to increase or decrease the fan speed by a greater amount in response to the deviation between the detected temperature and the desired temperature being greater, and by a lesser amount in response the deviation being lesser. Likewise, TEC controller(s) 154 may be configured to increase or decrease the temperature of cold plate 122 by a greater or lesser amount dependent on the deviation between the detected temperature and the desired temperature.

In some examples, the control system of water condensation device 100 (e.g., fan controller 150 and/or TEC controller(s) 154) is configured to operate substantially similarly to the control system of condensation core 2, discussed above with reference to FIG. 1. For example, the control system of water condensation device 100 may include processing logic and/or one or more algorithms configured to attempt to maximize the amount of water produced by condensation core 102 per amount of energy used. Explained in other words, the control system may be configured to dynamically control the electrical power provided to TEC module(s) 114 and/or the airflow rate of air passing over condensation member 112 to maintain condensation member 112 at a temperature that promotes water condensation, without exceeding the point where additional power input and/or additional airflow results in diminished cooling performance provided by TEC module(s) 114.

In some examples, condensation member 112 comprises a condensation prism 132 (AKA a porosity prism). Condensation prism 132 may comprise any suitable thermally conductive structure(s) (e.g., an aluminum structure) that defines an airflow channel 134 (e.g., a tortuous airflow channel or pathway) extending through condensation prism 132 along an airflow axis 136. Explained in other words, condensation prism 132 has a porous internal structure configured to permit air to pass through condensation prism 132. In some examples, airflow channel 134 and airflow axis 136 each extend along a longitudinal axis of condensation prism 132. Airflow channel 134 includes an inlet 138 and an outlet 140 disposed on opposing ends of condensation prism 132.

Condensation prism 132 may be shaped as a triangular prism having three faces 133, a rectangular prism or cube having four faces 133, and/or may have any other suitable shape, size, and/or number of faces 133. In some examples, one or more faces 133 of condensation prism 132 comprise cooling surface 126 that is configured to be contacted by cold plate 122 of thermoelectric cooling module 114. In some examples, condensation prism 132 may include bases 135 that are at least partially open to form inlet 138 and outlet 140 of airflow channel 134. Intake fan 104 and/or any other suitable air-moving device of water condensation device 100 is configured to draw in air from the surrounding environment and force the air through inlet 138, such that the air passes through airflow channel 134 and exits through outlet 140.

In some examples, condensation prism 132 comprises one or more deflection structures 142 disposed within airflow channel 134. The surfaces of deflection structures 142 may comprise condensation surfaces 128 of condensation member 112. For example, the surface temperature of deflection structures 142 is configured to be reduced by thermoelectric cooling module 114 in order to induce condensation of water on the surfaces of deflection structures 142. Deflection structures 142 are configured to increase turbulence of the air passing through airflow channel 134, without adding a substantial increase in the pressure differential between inlet 138 and outlet 140 of airflow channel 134. Additionally, deflection structures 142 increase the total surface area of the cooled surfaces of condensation prism 132. As such, deflection structures 142 are configured to reduce the speed of the air passing through airflow channel 134 and increase contact between the air and the cooled surfaces of condensation prism 132 in order to increase condensation on the cooled surfaces. Explained in other words, in some examples, condensation prism 132 defines a tortuous airflow channel or pathway that is obstructed by a plurality of deflection structures 142.

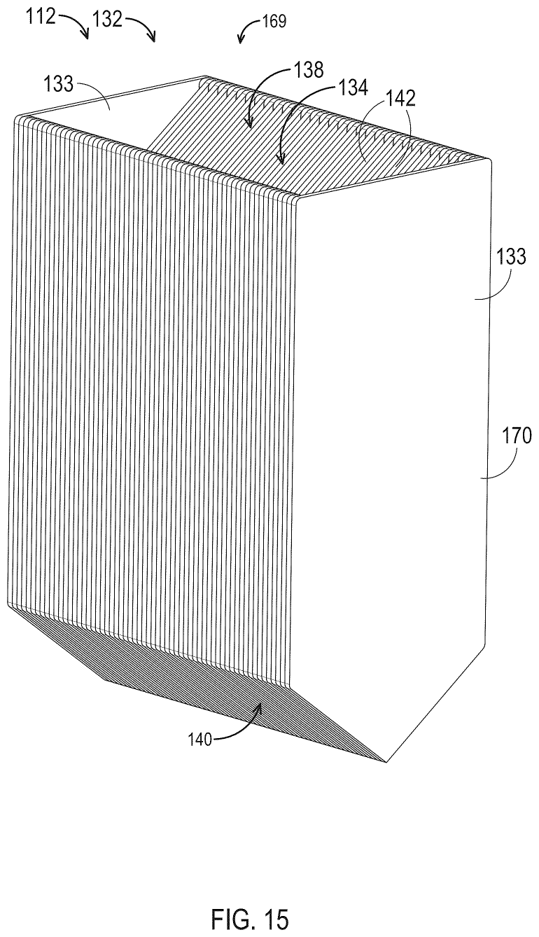

Condensation prism 132 may comprise any suitable deflection structures 142 arranged within airflow channel 134. In some examples, deflection structures 142 comprise a plurality of pegs 144 extending across airflow channel 134 transverse to airflow axis 136 between one or more of faces 133 of condensation prism 132. Condensation prism 132 may have any suitable number of pegs 144 and pegs 144 may be arranged in any suitable manner within airflow channel 134. For example, plurality of pegs 144 may be arranged in offset rows along airflow axis 136. Pegs 144 may each have any suitable cross-sectional width and/or shape, e.g., circular, rectangular, square, triangular, etc. Alternatively, or additionally to plurality of pegs 144, condensation prism 132 may have any other suitable deflection structures 142 positioned within airflow channel 134 that are configured to increase contact between the air that passes through airflow channel 134 and the cooled surfaces of condensation prism 132. For example, as shown in FIGS. 15-19 and discussed further below, condensation prism 132 may comprise a chevron prism 169 including a plurality of deflection structures 142 having a V-shape and/or an inverted V-shape that extend across and obstruct airflow channel 134.

Condensation prism 132 may be formed using casting, machining, forging, extrusion, additive manufacturing, and/or using any other suitable methods. In some examples, condensation prism 132 may be formed as a single piece and/or may comprise multiple parts that are coupled (e.g., fixed) to each other. Condensation prism 132 may comprise any suitable thermally conductive material configured to have its surface temperature reduced by thermoelectric cooling module(s) 114. In some examples, condensation prism 132 comprises a single piece thermally conductive structure (e.g., aluminum). In some examples, condensation prism 132 comprises multiple thermally conductive structures that are coupled to each other using any suitable method, e.g., using one or more fasteners, welding, adhesives, mating structures, etc.

In some examples, condensation member 112 (e.g., condensation prism 132) comprises one or more condensation surfaces 128 (e.g., the surfaces of deflection structures 142 of condensation prism 132) that are hydrophobic, hydrophilic, and/or have any other suitable surface wettability. For example, one or more surfaces of condensation member 112 may be treated with lasers and/or chemicals, such that condensation member 112 has a surface texture that is configured to repel water that condenses on the surfaces of condensation member 112. In such examples, this may prevent condensed water from becoming trapped or stuck on the surfaces of condensation member 112 (e.g., condensation prism 132) during use of water condensation device 100. In some examples, the one or more surfaces are treated with lasers and/or chemicals, such that the condensation member 112 has one or more hydrophilic surfaces. In such examples, the hydrophilic surfaces may facilitate increased water condensation on the hydrophilic surfaces and retaining the condensed water on the hydrophilic surfaces. In some examples, the hydrophilic surfaces exhibit capillary action, e.g., the hydrophilic surfaces may be configured to transport condensed water upwards against gravity.

In some examples, condensation member 112 includes one or more hydrophobic surfaces that are configured to facilitate the condensed water exiting water condensation device 100 to be received by water collector 108. For example, as shown in FIG. 2, water collector 108 may be positioned beneath outlet 140 of condensation prism 132 in order to facilitate gravity forcing the condensed water downward through airflow channel 134 and out through outlet 140 to be received by water collector 108. In such examples, the interior surfaces of condensation prism 132 (e.g., the surfaces of deflection structures 142) may be hydrophobic surfaces to prevent water that condenses on the interior surfaces from becoming trapped within airflow channel 134.

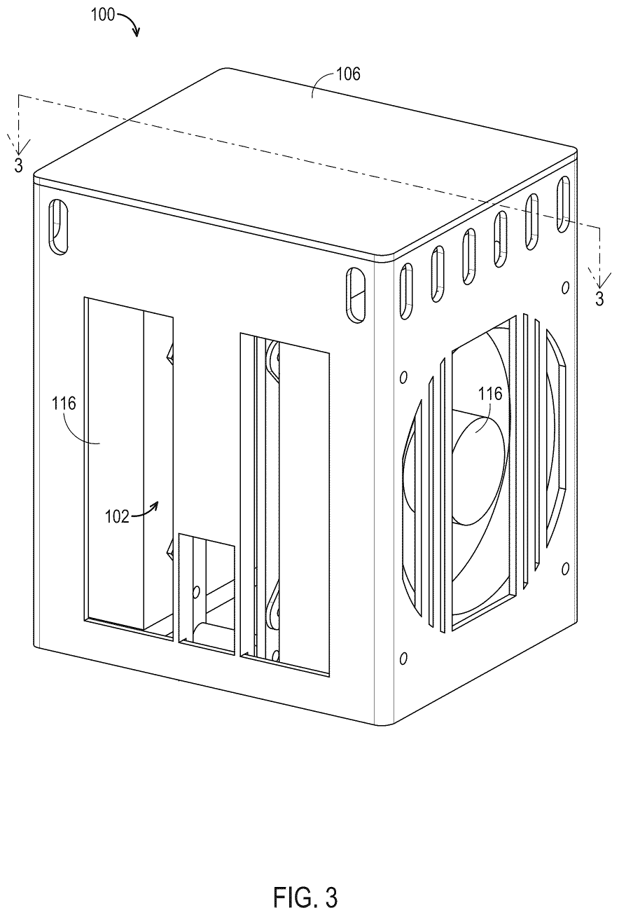

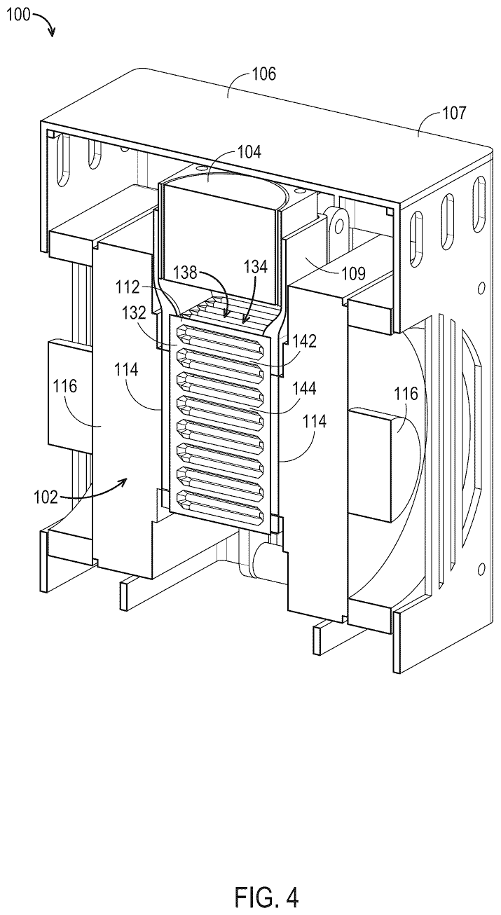

FIGS. 3 and 4 illustrate a first non-limiting example of water condensation device 100, which is schematically shown in FIG. 2. FIG. 4 illustrates a sectional view of the example water condensation device 100 of FIG. 3 corresponding to line 3-3 in FIG. 3. As shown in FIGS. 3-4, the example water condensation device 100 includes a condensation core 102, an intake fan 104, and a housing 106 that supports intake fan 104 and condensation core 102. Housing 106 includes an outer housing 107 and an inner housing 109 that is coupled to and supported by outer housing 107. Condensation core 102 and intake fan 104 are operatively coupled to and supported by inner housing 109.

Condensation core 102 includes a condensation member 112 comprising a condensation prism 132. Condensation prism 132 is sandwiched between a pair of thermoelectric cooling modules 114, each configured to absorb heat from condensation prism 132 to reduce the surface temperature of condensation prism 132. Each thermoelectric cooling module 114 is operatively coupled to a respective heat sink 116 comprising a fan 117 that is configured to dissipate the heat absorbed by thermoelectric cooling module 114 into the surrounding environment.

As shown in FIG. 4, intake fan 104 is positioned above an inlet 138 of an airflow channel 134 defined by condensation prism 132 and is configured to force air to pass through airflow channel 134 extending through condensation prism 132. Condensation prism 132 includes a plurality of deflection structures 142 comprising a plurality of offset pegs 144 that are arranged within airflow channel 134 that are configured to increase contact between the air and the cooled surfaces of condensation prism 132 in order to increase condensation on the surfaces of condensation prism 132.

As shown in FIG. 4, in some examples, plurality of pegs 144 extend across airflow channel 134 between the faces of condensation prism 132 that are contacted by thermoelectric cooling modules 114. Explained in other words, each end of pegs 144 may be coupled to the faces of condensation prism that are in contact with thermoelectric cooling modules 114. This facilitates thermoelectric cooling modules 114 lowering the surface temperature of plurality of pegs 144 through direct contact with the faces of condensation prism 132.

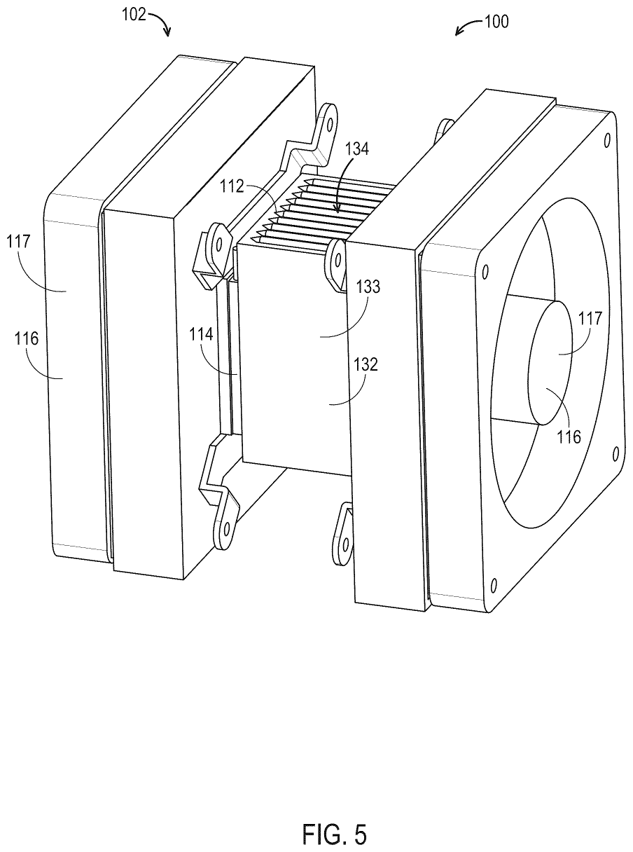

FIGS. 5 and 6 illustrate non-limiting examples of condensation core 102 of water condensation device 100, described above. FIG. 5 illustrates the condensation core 102 shown and described in FIGS. 3 and 4 above. The example condensation core 102 shown in FIG. 5 includes a condensation prism 132 comprising a rectangular prism having four faces 133, a pair of thermoelectric cooling modules 114, and a pair of heat sinks 116 comprising fans 117 operatively coupled to thermoelectric cooling modules 114.

FIG. 6 illustrates another example of a condensation core 102 that may be utilized in water condensation device 100, as described above. The example condensation core 102 shown in FIG. 6 includes a condensation prism 132 comprising a triangular prism having three faces 133, three thermoelectric cooling modules 114 each contacting a respective face 133 of condensation prism 132, and three heat sinks 116 each operatively connected to a respective one of thermoelectric cooling modules 114. In the example of FIG. 6, heat sinks 116 comprise water-cooling blocks 121 having one or more fluid lines 123 that run internally within water-cooling blocks 121 and that are configured to receive a cooled liquid. Water-cooling blocks 121 comprise a thermally conductive material (e.g., aluminum, copper, etc.) that is configured to be cooled by the cooled liquid received within fluid lines 123 and to absorb heat from thermoelectric cooling module 114. Alternatively, heat sinks 116 may comprise fans 117, as described above.

As shown in FIG. 6, in some examples, condensation core 102 further comprises clamps 160 and/or any other suitable structures configured to secure the components of condensation core to each other. For example, clamps 160 in FIG. 6 are configured to securely hold heat sinks 116 and thermoelectric cooling modules 114 in contact with faces 133 of condensation prism 132.

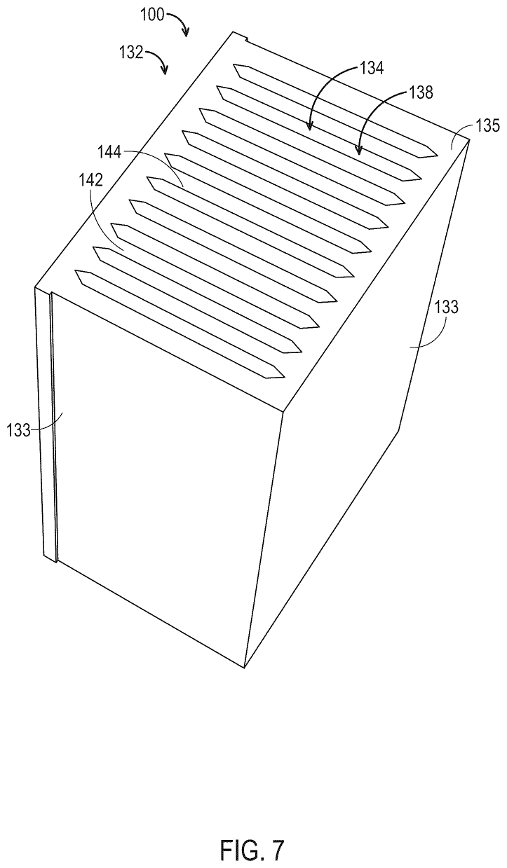

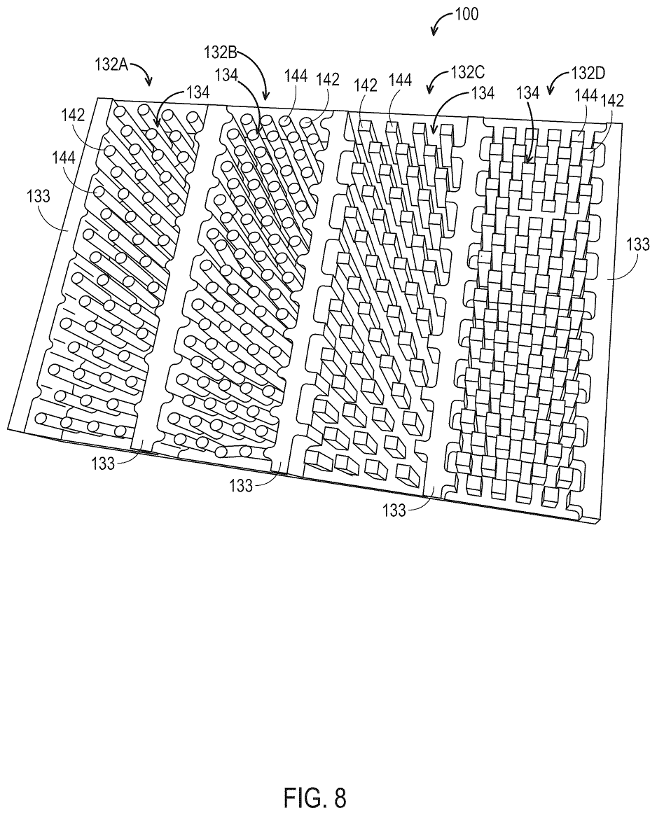

FIGS. 7-19 illustrate non-limiting examples of condensation prisms 132 that may be utilized in water condensation device 100, as described above. As shown in FIG. 7, in some examples, condensation prism 132 comprises a rectangular prism having four faces 133 defining an airflow channel 134 and a plurality of deflection structures 142. In the example of FIG. 7, deflection structures 142 comprise a plurality of pegs 144 extending across airflow channel 134 between faces 133. FIG. 8 illustrates a sectional view of four example condensation prisms 132A, 132B, 132C, 132D. As shown in FIG. 8, in each of the four example condensation prisms 132A-D, deflection structures 142 comprise a plurality of pegs 144 that extend across airflow channel 134 in offset rows. Example condensation prisms 132A and 132B each include pegs 144 having a circular cross-sectional shape, whereas example condensation prisms 132C and 132D each include pegs 144 that have a square or rectangular cross-sectional shape.

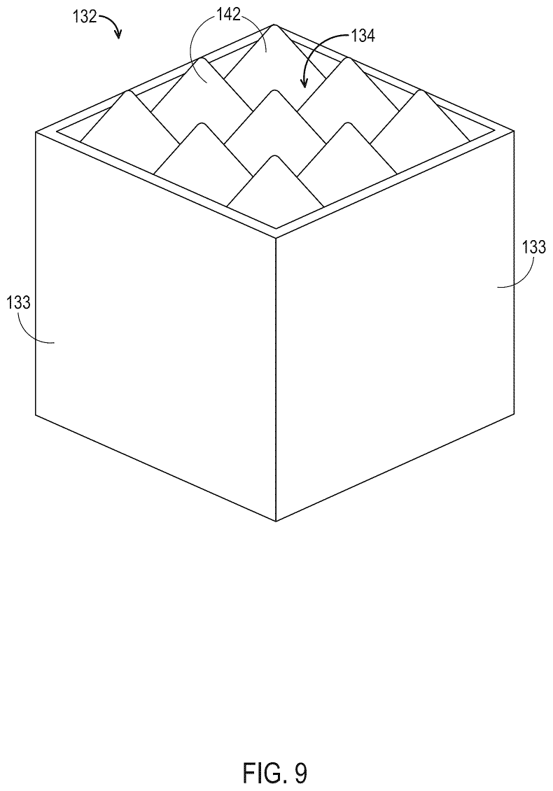

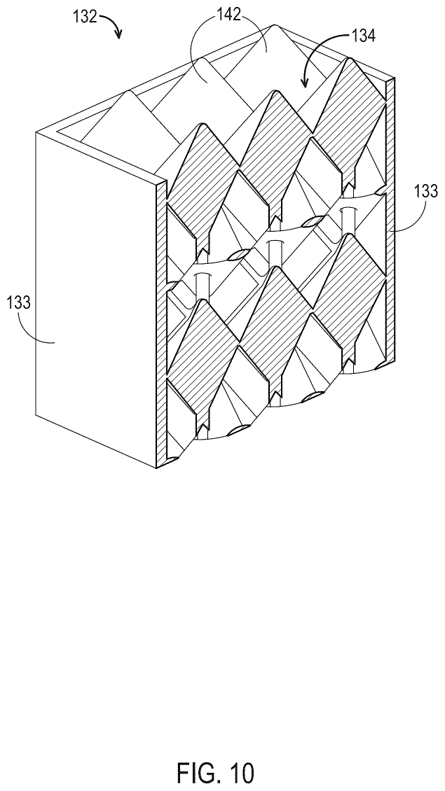

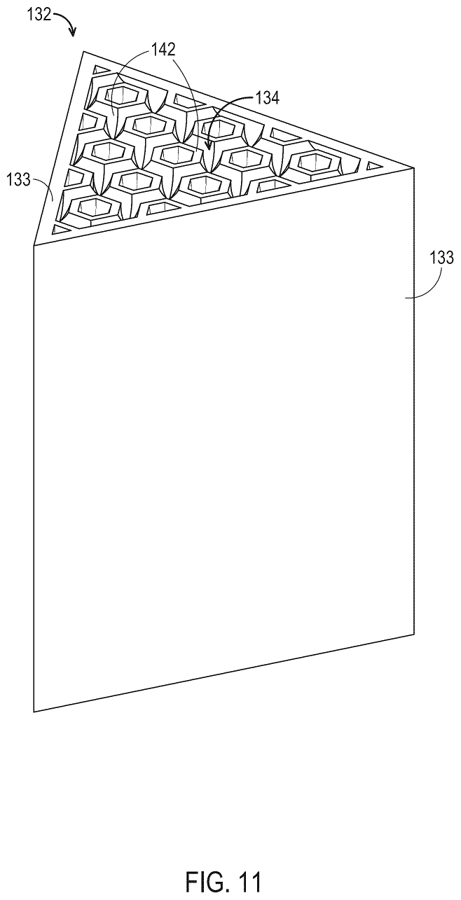

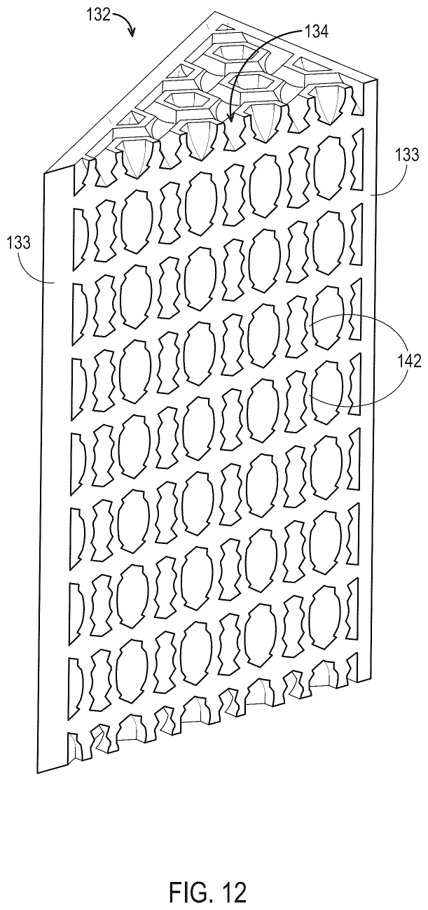

FIGS. 9 and 10 illustrate another example condensation prism 132 comprising a rectangular prism having four faces 133 defining an airflow channel 134. The example condensation prism 132 of FIGS. 9 and 10 includes a plurality of offset rows of cone-shaped deflection structures 142 disposed within and obstructing airflow channel 134. FIGS. 11 and 12 illustrate another example condensation prism 132 comprising a triangular prism having three faces 133. The example condensation prism 132 of FIGS. 11 and 12 includes a porous internal structure that is configured to permit air to pass through condensation prism 132 from inlet to outlet. The porous internal structure includes a plurality of interconnected deflection structures 142 configured to increase contact between the cooled surfaces of condensation prism 132 and air passing through condensation prism 132. As described above, in each example condensation prism 132, deflection structures 142 are configured to increase the surface area of the cooled surfaces of condensation prism 132 and increase turbulence and contact between the air passing through airflow channel 134 and the cooled surfaces of condensation prism 132, without adding a substantial increase in the pressure differential between the inlet and the outlet of airflow channel 134.

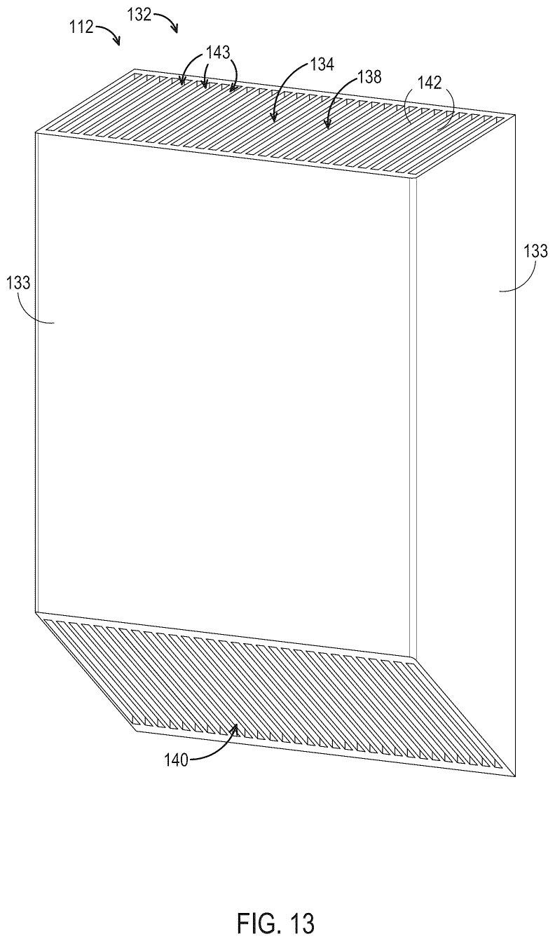

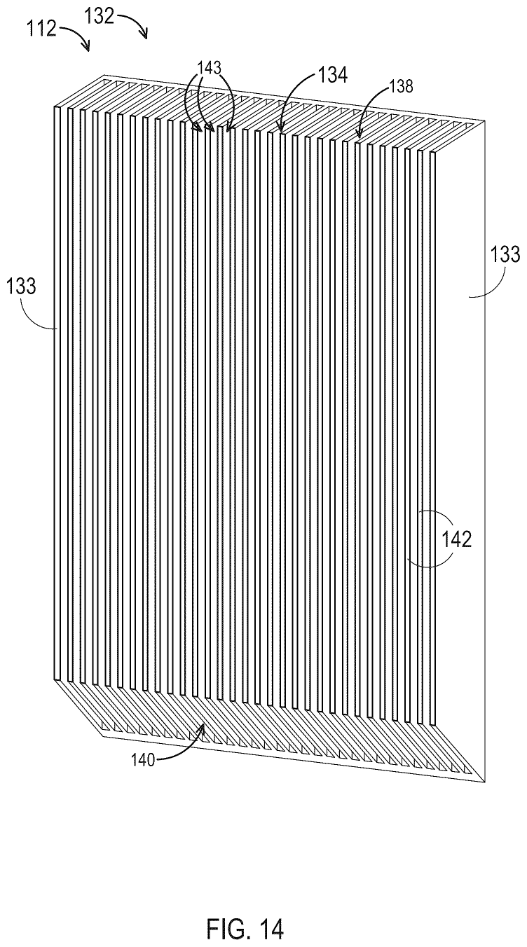

FIGS. 13-14 illustrate another example condensation prism 132. The example condensation prism 132 shown in FIGS. 13-14 includes a plurality of planar deflection structures 142 that define and/or form a plurality of vertically-oriented airflow slots 143. Explained in other words, the example condensation prism 132 shown in FIGS. 13-14 includes an airflow channel 134 that is divided into a plurality of airflow slots 143 formed between deflection structures 142. Air is permitted to pass through airflow slots 143 from an air inlet 138 to an air outlet 140 defined by condensation prism 132. As shown in FIGS. 13 and 14, in some examples, the bottom face or base of condensation prism 132 is angled (e.g., beveled) and air outlet 140 is formed in the angled bottom face of condensation prism 132.

FIGS. 15-19 illustrate example chevron condensation prisms 169 (AKA chevron prisms). Chevron prisms 169 are an example of condensation prisms 132, which may be utilized in water condensation device 100. As shown in FIGS. 15-19, each chevron prism 169 defines an airflow channel 134 and includes a plurality of V-shaped deflection structures 142A, 142B (AKA chevron-shaped deflection structures) extending across airflow channel 134. In the examples of FIGS. 15-19, V-shaped deflection structures 142A, 142B are vertically oriented As shown in FIGS. 15-19, airflow channel 134 includes a V-shaped inlet 138 and a V-shaped outlet 140 formed by V-shaped deflection structures 142A, 142B at upper and lower ends of chevron prism 169.

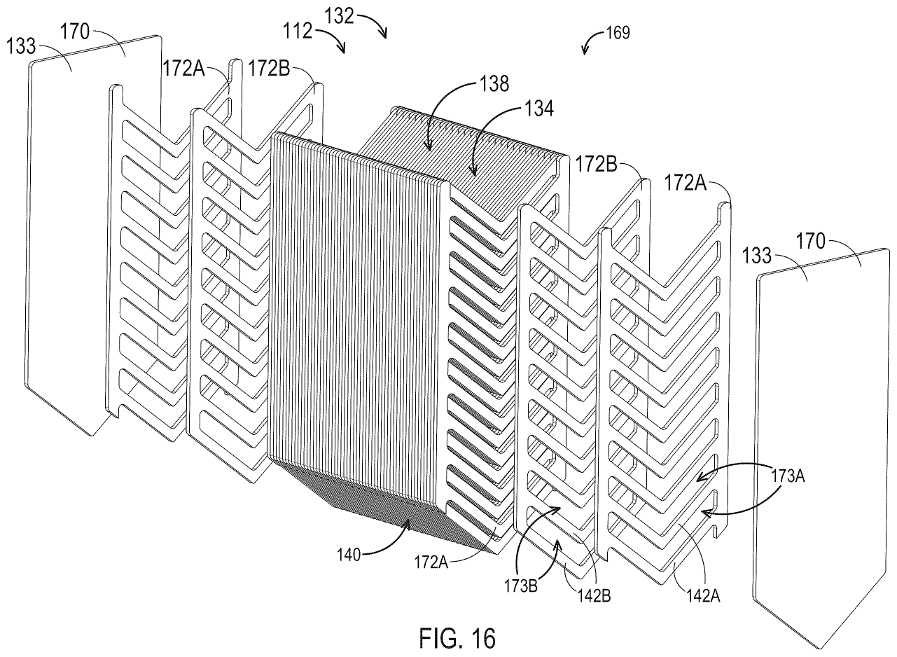

FIGS. 15-16 illustrate a first example of a chevron prism 169. As shown in FIGS. 15-16, chevron prism 169 may include a plurality of chevron plates 172A, 172B sandwiched between a pair of end plates 170. Each chevron plate 172A, 172B may comprise a metal plate (e.g., aluminum plate) including a plurality of V-shaped deflection structures 142A, 142B that define a plurality of V-shaped slots 173A, 173B (AKA chevron-shaped slots) formed in the respective chevron plates. Explained in other words, each chevron plate 172A, 172B includes a plurality of deflection structures 142A, 142B that have the shape of a chevron and that define a plurality of slots 173A, 173B having the shape of a chevron. End plates 170 may comprise planar metal plates disposed on opposing ends of the plurality of first and second chevron plates 172A, 172B. In some examples, as shown in FIGS. 15 and 16, end plates 170 do not include or define any slots.

In the example of FIGS. 15-16, chevron prism 169 includes a plurality of first chevron plates 172A and a plurality of second chevron plates 172B that are arranged alternatingly between end plates 170. Each first chevron plate 172A includes a plurality of first V-shaped deflection structures 142A defining first V-shaped slots 173A in first chevron plates 172A and each second chevron plate 172B includes a plurality of second V-shaped deflection structures 142B defining second V-shaped slots 173B in the second chevron plate 172B. When coupled to each other in the alternating arrangement shown in FIG. 16, first V-shaped deflection structures 142A of first chevron plates 172A are offset (e.g., in a vertical direction) from second V-shaped deflection structures 142B of second chevron plates 172B. An airflow channel 134 is defined between the plurality of first and second chevron plates 172A, 172B, such that air is permitted to flow from V-shaped air inlet 138 to V-shaped air outlet 140 through first and second V-shaped slots 173A, 173B formed in first and second chevron plates 172A, 172B.

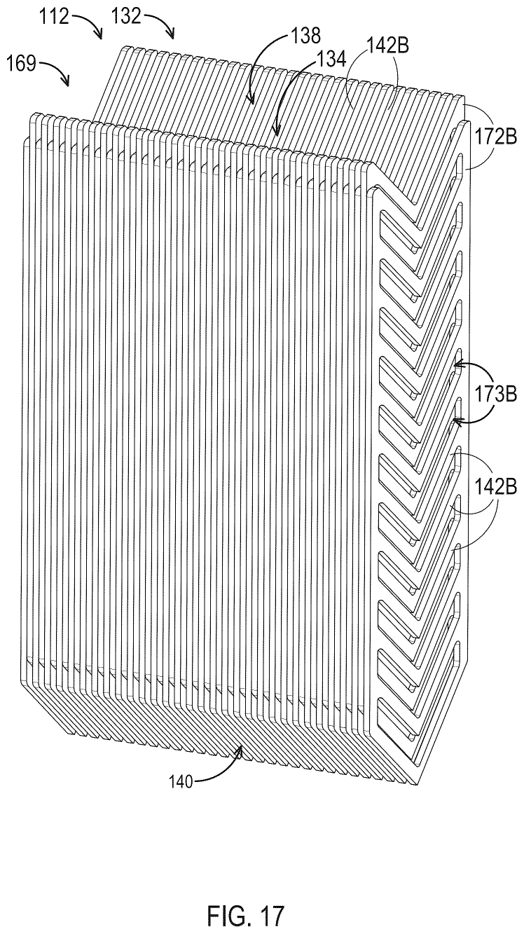

FIG. 17 illustrates a second example chevron prism 169. As shown in FIG. 17, chevron prism 169 includes a plurality of the second chevron plates 172B discussed above with reference to FIGS. 15-16. As shown in FIG. 17, the plurality of second chevron plates 172B are arranged adjacent to each other at offset heights, such that second V-shaped deflection structures 142B and second V-shaped slots 173B of adjacent second chevron plates 172B are offset from each other, e.g., in the vertical direction. An airflow channel 134 is defined between the plurality of second chevron plates 172B from V-shaped air inlet 138 to V-shaped air outlet 140 and air is permitted to flow through the offset second V-shaped slots 173B formed in the plurality of second chevron plates 172B. In FIG. 17, chevron prism 169 is shown without end plates 170. However, in some examples, chevron prism 169 shown in FIG. 17 includes substantially similar end plates 170 to those shown in FIGS. 15 and 16.

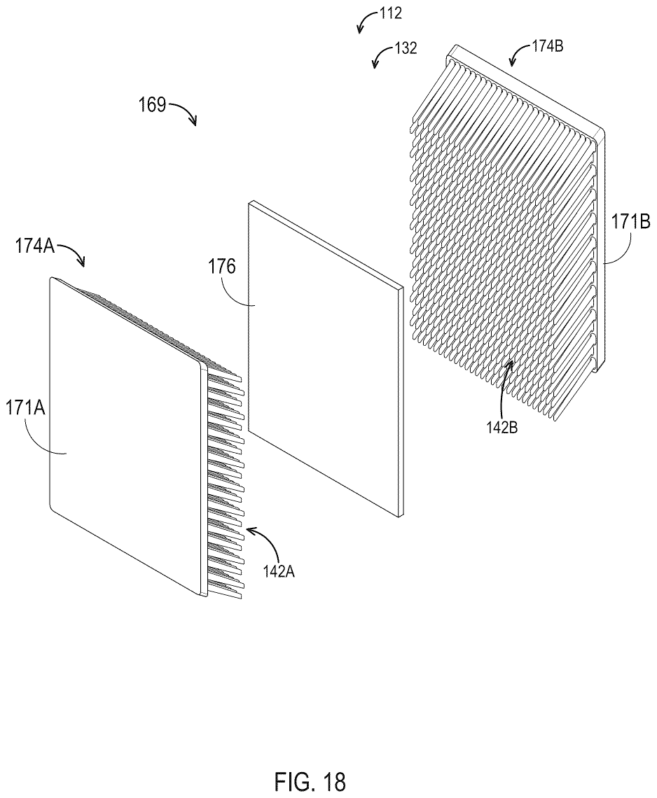

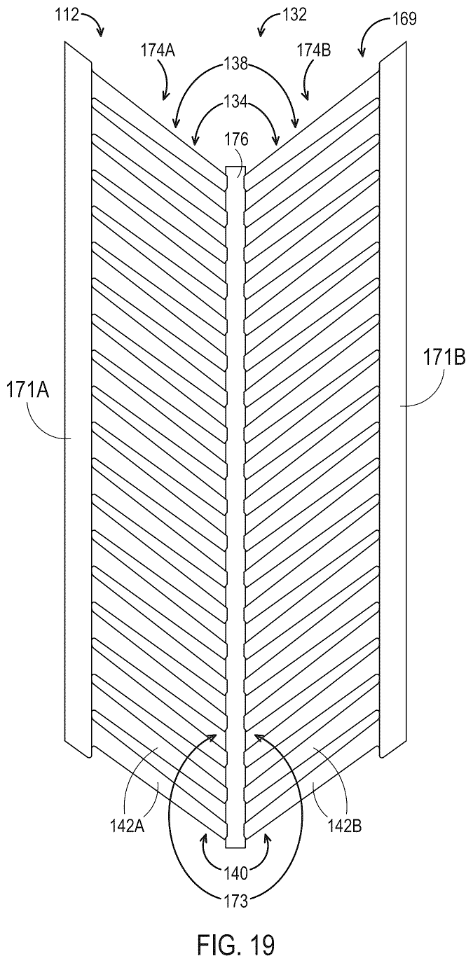

FIGS. 18-19 illustrate another example chevron prism 169. As shown in FIGS. 18-19, chevron prism 169 may include a pair of chevron halves 174A, 174B each comprising a metal structure including an external face plate 171A, 171B and a plurality of deflections structures 142A, 142B extending from external face plate 171A, 171B. As shown in FIGS. 18 and 19, chevron halves 174A, 174B are configured to be coupled (e.g., fixed) to each other to form chevron prism 169. In some examples, a central plate 176 is disposed between chevron halves 174A, 174B. First and second chevron halves 174A, 174B may be coupled (e.g., fixed) to the opposing sides of central plate 176 in any suitable manner, e.g., welding, fasteners, etc. For example, distal ends of the plurality of deflection structures 142A, 142B of the pair of chevron halves 174A, 174B may be fixed to opposing sides of central plate 176 to form chevron prism 169.

As shown in FIG. 19, the plurality of deflection structures 142A, 142B of the pair of chevron halves 174A, 174B align to form a plurality of V-shaped and/or chevron-shape deflection structures defining V-shaped and/or chevron-shaped slots 173. V-shaped slots 173 are intersected (e.g., bisected) by central plate 176, which extends vertically between chevron halves 174A, 174B. In some examples, as shown in FIG. 19, V-shaped slots 173 are vertically aligned with each other across chevron prism 169.

Chevron prism 169 may be manufactured in any suitable manner. For example, as shown in FIGS. 15-17, chevron prism 169 may include a plurality of first and/or second chevron plates 172A, 172B. In some examples, the plurality of first and/or second chevron plates 172A, 172B are manufactured individually and are coupled to each other in any suitable manner. For example, the plurality of first and/or second chevron plates 172A, 172B may be coupled to each other using one or more reusable fasteners (e.g., bolts, screws, rivets, etc.) and/or using any other suitable methods configured to permit the plurality of first and/or second chevron plates 172A, 172B to be selectively disassembled to allow for cleaning and/or inspection. Alternatively, in some examples, the plurality of first and/or second chevron plates 172A, 172B may be coupled to each other using any suitable methods configured to permanently attach chevron plates 172A, 172B to each other, such that chevron plates 172A, 172B are inseparable other than by using destructive methods. For example, chevron plates 172A, 172B may be coupled to each other using any suitable single-use fasteners, welding, diffusion bonding, and/or using any other suitable permanent coupling methods.

In some examples, as shown in FIGS. 18-19, chevron prism 169 may include two or more pieces (e.g., a pair of chevron halves 174A, 174B) configured to be coupled to each other to form chevron prism 169. Each of chevron halves 174A, 174B may comprise a metal structure formed by metal casting and/or using any other suitable methods. Chevron halves 174A, 174B may be coupled to each other in any suitable manner. For example, chevron halves 174A, 174B may be coupled to each other using one or more reusable fasteners (e.g., bolts, screws, etc.) and/or using any other suitable method configured to permit selective disassembly of chevron prism 169 to allow for cleaning and/or inspection. Alternatively, in some examples, chevron halves 174A, 174B may be permanently coupled to each other in any suitable manner, such that chevron halves 174A, 174B are inseparable other than by using destructive methods. For example, chevron halves 174A, 174B may be coupled to each other using any suitable single-use fasteners, welding, diffusion bonding, and/or using any other suitable permanent coupling methods. Alternatively, in some examples, chevron prism 169 may be formed as a single piece structure using any suitable methods, e.g., casting, additive manufacturing, etc.

As shown in FIGS. 15-19, chevron prism 169 includes V-shaped deflection structures 142A, 142B that form a V-shaped inlet 138 and a V-shaped outlet 140 of airflow channel 134. In some examples, chevron prism 169 is configured to be arranged in a water condensation device 100, such that air intake fan 104 is configured to force air through V-shaped inlet 138 and the air passes through airflow channel 134 and exits through V-shaped outlet 140. In some examples, V-shaped deflection structures 142A, 142B of chevron prism 169 are configured to promote and/or increase the drainage of condensed water from chevron prism 169 through V-shaped outlet 140. For example, water that condenses on V-shaped deflection structures 142A, 142B may slide on V-shaped deflection structures 142A, 142B to the center of V-shaped deflection structures 142A, 142B, e.g., to the vertex of the V-shaped deflection structures 142A, 142B. This may increase water drainage from chevron prism 169 and/or decrease the amount of water that is trapped by chevron prism 169. Additionally, the V-shaped outlet 140 facilitates water draining from the center line or vertex of V-shaped outlet 140. This may ease the water collection process by limiting water drainage to a defined area or region of chevron prism 169. The air that is forced through airflow channel 134 may vent from V-shaped outlet 140 on either side of the centerline or vertex of V-shaped outlet 140.

V-shaped deflection structures 142A, 142B, V-shaped inlet 138, and/or V-shaped outlet 140 may have any suitable vertex angle. Explained in other words, each V-shaped deflection structure 142A, 142B may comprise a pair of arms joined at a central vertex with the vertex angle being the angle between the pair of arms. A greater vertex angle results in the arms of V-shaped deflection structures 142A, 142B being oriented less vertically than a lesser vertex angle. As such, increasing the vertex angle decreases the vertical height of V-shaped outlet 140 and chevron prism 169 and decreasing the vertex angle increases the vertical length of V-shaped outlet 140 and chevron prism 169. In some examples, decreasing the vertex angle, which increases the vertical length or height of chevron prism 169, may improve water drainage. In some examples, increasing the vertex angle, which decreases the vertical length or height of chevron prism 169, may increase the water condensation on the surfaces of chevron prism 169. Chevron prism 169 may have any suitable vertex angle configured to promote water drainage and/or water condensation efficiency.

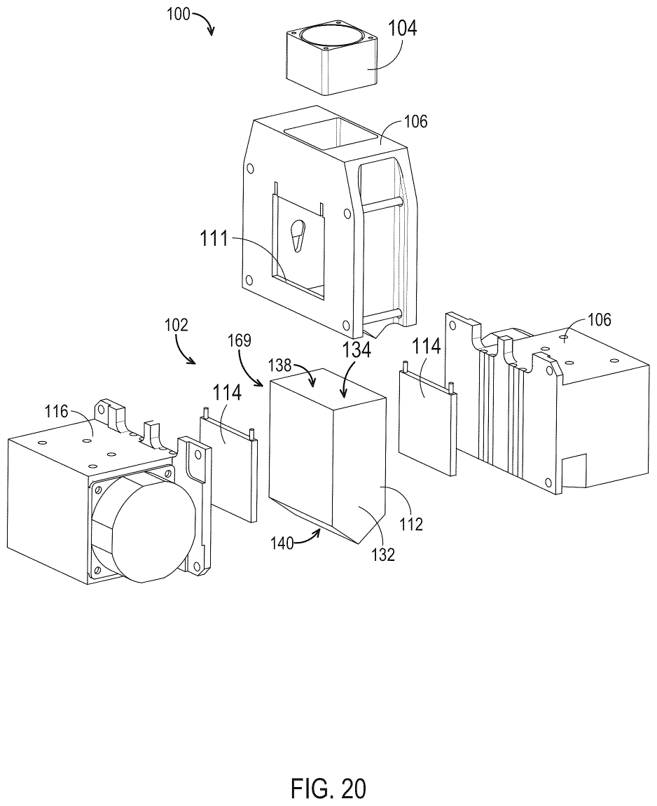

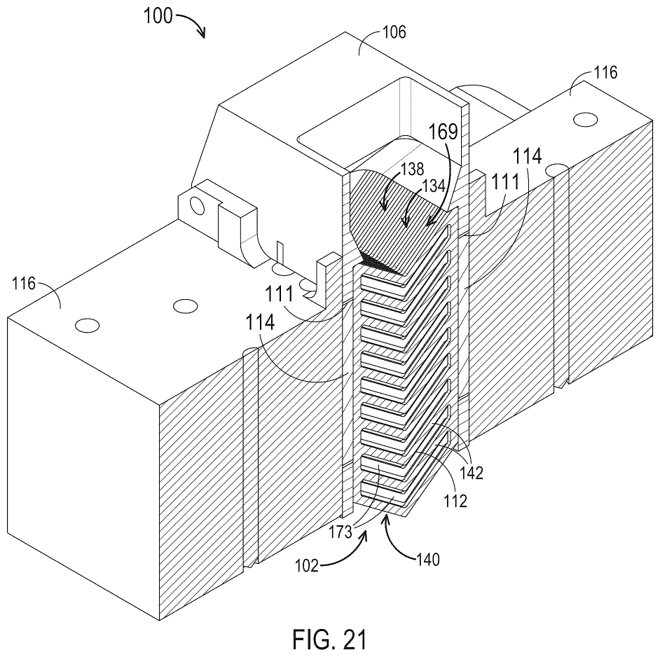

Chevron prism 169 is configured to be utilized as a condensation member 112 of water condensation devices 100 discussed herein. In some examples, one or more thermoelectric cooling modules 114 may be positioned in direct contact with chevron prism 169, such that thermoelectric cooling modules 114 are configured to reduce the surface temperature of chevron prism 169 to induce condensation of water vapor on the surfaces of chevron prism 169, e.g., on the surfaces of deflection structures 142A, 142B. In some examples, as shown in FIGS. 20 and 21 below, a pair of thermoelectric cooling modules 114 are placed in direct contact with longitudinal lateral sides of chevron prism 169, which are formed by lateral edges of the plurality of first and/or second chevron plates 172A, 172B. Explained in other words, thermoelectric cooling modules 114 may directly contact lateral sides of chevron prism 169 formed by lateral edges of first and/or second chevron plates 172A, 172B rather than directly contacting end plates 170 on opposing ends of chevron prism 169. Additionally, and/or alternatively, one or more thermoelectric cooling modules 114 may be placed in contact with end plates 170. In some examples, as shown in FIGS. 18 and 19, chevron prism 169 includes respective chevron halves 174A, 174B each including respective external face plates 171A, 171B. In such examples, one or more thermoelectric cooling modules 114 may directly contact external face plates 171A, 171B of chevron halves 174A, 174B.

FIGS. 20-21 illustrate a second non-limiting example of water condensation device 100, which is schematically shown in FIG. 2. As shown in FIGS. 20 and 21, in some examples, water condensation device 100 includes a condensation member 112 comprising a chevron prism 169, such as any one of chevron prisms 169 described above with reference to FIGS. 15-19.

As shown in FIGS. 20 and 21, water condensation device 100 includes a housing 106, an intake fan 104, and a condensation core 102. Housing 106 is configured to support intake fan 104 and the components of condensation core 102. As shown in FIGS. 20 and 21, in some examples, housing 106 includes one or more recesses 111 formed in the walls of housing 106. Recesses 111 may be sized and/or shaped to receive thermoelectric cooling modules 114 of condensation core 102 when water condensation device 100 is assembled. This facilitates positioning thermoelectric cooling modules 114 in contact with chevron prism 169 disposed within housing 106.

Condensation core 102 includes a condensation member 112 comprising a chevron prism 169, a pair of thermoelectric cooling modules 114, and a pair of heat sinks 116. Thermoelectric cooling modules 114 contact chevron prism 169 and are configured to reduce the surface temperature of chevron prism 169 to induce condensation of water vapor on the surfaces of chevron prism 169. Each heat sink 116 is operatively coupled to a respective one of thermoelectric cooling modules 114 and is configured to dissipate heat from the respective one of thermoelectric cooling modules 114. FIG. 21 illustrates a sectional view of water condensation device 100 including chevron prism 169. As shown in FIG. 21, chevron prism 169 defines an airflow channel 134 extending from a V-shaped inlet 138 formed in an upper face of chevron prism 169 to a V-shaped outlet 140 formed in a lower or bottom face of chevron prism 169. Intake fan 104 is configured to be disposed above V-shaped inlet 138 and is configured to force air through V-shaped inlet 138 into airflow channel 134. Chevron prism 169 includes a plurality of V-shaped deflection structures 142 extending across and obstructing airflow channel 134. V-shaped deflection structures 142 are configured to increase turbulence of the air passing through airflow channel 134, without adding a substantial increase in the pressure differential between V-shaped inlet 138 and V-shaped outlet 140. Additionally, V-shaped deflection structures 142 increase the total surface area of the cooled surfaces of chevron prism 169. As such, V-shaped deflection structures 142 are configured to reduce the speed of the air passing through airflow channel 134 and increase contact between the air and the cooled surfaces of chevron prism 169 in order to increase condensation on the cooled surfaces.

### C. Second Illustrative Water Condensation Device

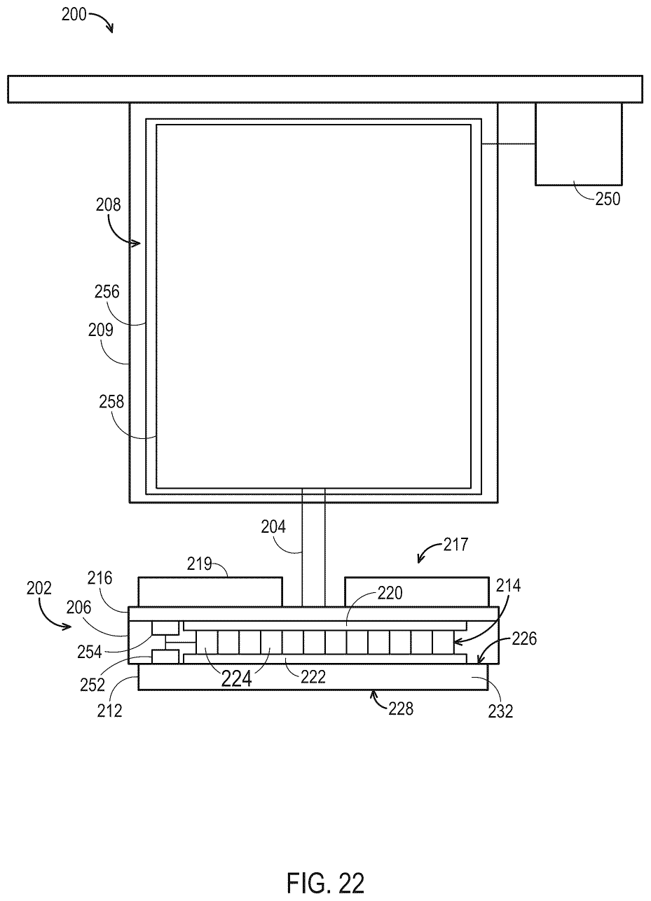

As shown in FIGS. 22-25, this section describes a second illustrative water condensation device 200. Water condensation device 200 is an example of water condensation devices, described above in the Overview.

As shown in FIG. 22, similarly to water condensation device 100 described above, water condensation device 200 includes a condensation core 202 including a condensation member 212, a thermoelectric cooling (TEC) module 214 (AKA thermoelectric module), and a heat sink 216. Condensation core 202 is an example of condensation core 2 discussed above with reference to FIG. 1. In some examples, condensation core 202 is supported by and coupled to a mounting plate 206 configured to secure the components of condensation core 202 to each other.

Thermoelectric cooling module 214 is substantially similar to thermoelectric cooling module 114 described above with reference to water condensation device 100. For example, thermoelectric cooling module 214 comprises a hot plate 220 (AKA hot surface) and a cold plate 222 (AKA cold surface) separated by a plurality of semiconductors 224. When thermoelectric cooling module 214 is electrically connected to a battery and/or any other suitable direct current (DC) electrical power source, thermoelectric cooling module 214 is configured to actively transfer and/or pump heat from cold plate 222 to hot plate 220 through plurality of semiconductors 224. In some examples, as described further below, water condensation device 200 includes a TEC controller 254 (AKA thermoelectric-module controller) configured to selectively control the electrical power supplied to thermoelectric cooling module 214 in order to regulate the temperature of cold plate 222.

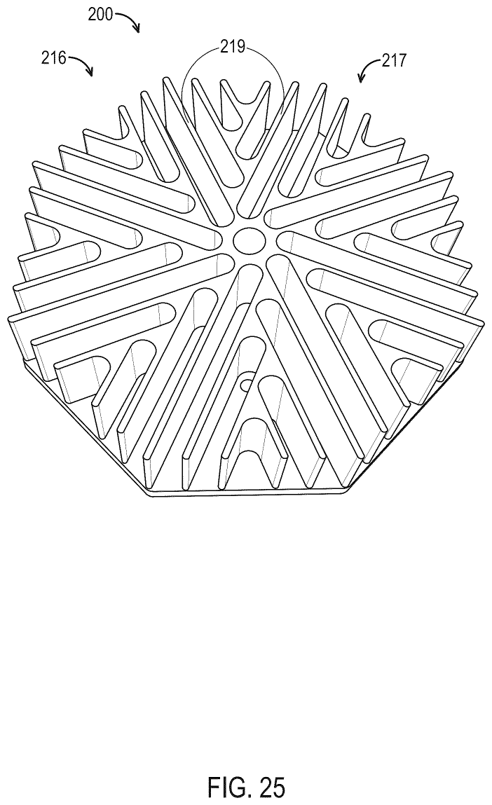

As shown in FIG. 22, cold plate 222 of thermoelectric cooling module 214 is coupled to (e.g., in direct contact with) condensation member 212 and is configured to draw heat away from condensation member 212 to reduce a surface temperature of condensation member 212. Heat sink 216 is coupled to hot plate 220 and is configured to absorb and/or dissipate heat from hot plate 220 into a surrounding environment. Heat sink 216 may comprise any suitable structure(s) that are configured to absorb heat from hot plate 220 and/or dissipate the heat into a surrounding environment. In some examples, heat sink 216 comprises a heat-sink fan 217 having a plurality of fins 219. Fins 219 are configured to increase the surface area of heat-sink fan 217 and increase heat dissipation by heat-sink fan 217. An example heat-sink fan 217 is shown in FIG. 25. As shown in FIG. 25, heat-sink fan 217 comprises a plurality of fins 219 having different lengths than each other. As discussed below, in some examples, condensation core 202 is configured to be rotated by an electric motor. In such examples, rotating condensation core 202 rotates fins 219 of heat-sink fan 217 to facilitate heat-sink fan 217 dissipating heat into the surrounding environment.

Condensation member 212 may comprise any suitable structure(s) that are configured to be cooled by thermoelectric cooling module 214 and that provide a condensation surface 228 on which water vapor from air that contacts condensation member 212 may condense into liquid water. In some examples, condensation member 212 comprises a thermally conductive metal plate 232 having any suitable, shape, size, and/or thickness. For example, metal plate 232 may comprise aluminum. Metal plate 232 may have a first side forming a cooling surface 226 of condensation member 212 that is in contact with cold plate 222 and a second opposite side that comprises condensation surface 228. In some examples, both cooling surface 226 and condensation surface 228 are substantially planar surfaces. A surface temperature of condensation surface 228 is configured to be reduced by cold plate 222 contacting cooling surface 226.

Water condensation device 200 is configured to force air to contact and/or pass over condensation member 212 by rotating condensation core 202. Water condensation device 200 may comprise any suitable mechanism(s) configured to selectively rotate and/or otherwise move condensation core 202 to cause air to pass over condensation member 212. For example, as shown in FIG. 22, condensation core 202 is operatively coupled (e.g., mounted) on a shaft 204 operatively connected to an electric motor 208. In other words, condensation member 212, thermoelectric cooling module 214, and heat sink 216 are mounted, e.g., coaxially on shaft 204. Electric motor 208 is configured to selectively rotate shaft 204 and condensation core 202 mounted on shaft 204. Rotating shaft 204 is configured to cause air to pass over condensation surface 228 of condensation member 212, which is exposed to the surrounding environment. As described above, condensation surface 228 is cooled by thermoelectric cooling module 214, such that condensation surface 228 is configured to cool the air and induce condensation of water vapor on condensation surface 228. In some examples, as water condenses on condensation surface 228 and condensation member 212 is rotated on rotating shaft 204, the condensed water is thrown or projected outward off of condensation surface 228. When shaft 204 is rotated, fins 219 of heat-sink fan 217 are rotated to facilitate heat-sink fan 217 dissipating heat into the surrounding environment.

Electric motor 208 may comprise any suitable mechanisms configured to selectively rotate condensation core 202 on shaft 204. In some examples, electric motor 208 comprises a stator 256 that is configured to rotate a rotor 258. Shaft 204 is operatively connected to rotor 258, such that shaft 204 is configured to rotate with rotor 258 relative to stator 256. In some examples, electric motor 208 comprises a slip ring motor. In some examples, electric motor 208 is housed within and/or supported by a motor housing 209. Water condensation device 200 may comprise any suitable electric power supply configured to supply electrical power to electric motor 208.

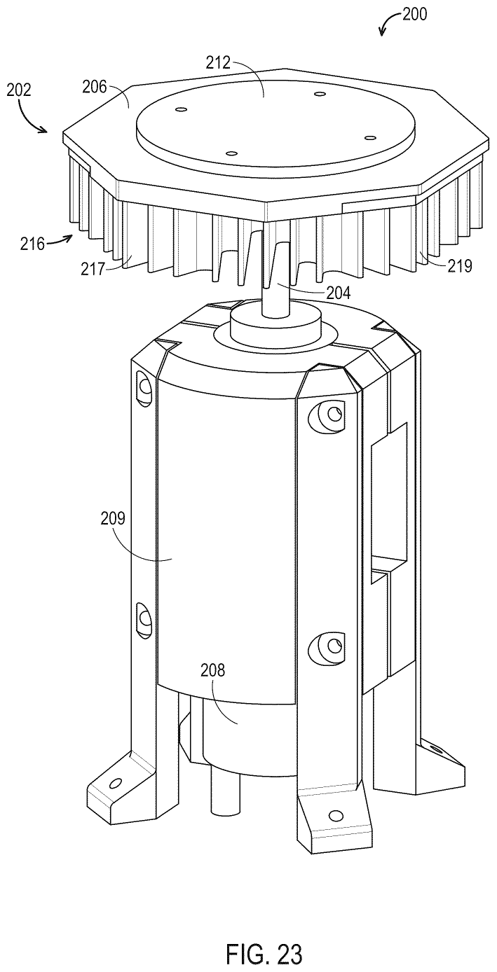

In some examples, as shown in FIG. 22, water condensation device 200 is configured to be oriented during use, such that heat sink 216 is disposed above thermoelectric cooling module 214 and condensation member 212. In other words, thermoelectric cooling module 214 may be sandwiched between heat sink 216 and condensation member 212 with condensation member 212 disposed beneath both heat sink 216 and thermoelectric cooling module 214. This orientation of water condensation device 200 facilitates improved heat dissipation by heat sink 216 as a result of the heat rising upward from thermoelectric cooling module 214. Additionally, this orientation of water condensation device 200 facilitates condensed water being forced downward off of condensation member 212 by gravity. Alternatively, as shown in FIG. 23 illustrating an example of water condensation device 200, water condensation device 200 may be oriented, such that condensation member 212 is disposed above thermoelectric cooling module 214 and heat sink 216.

In some examples, condensation surface 228 of condensation member 212 is hydrophobic, hydrophilic, and/or may have any other suitable surface wettability. For example, condensation surface 228 may be treated with lasers and/or chemicals, such that condensation surface 228 has a surface texture that is configured to repel water that condenses on condensation surface 228. In some examples, condensation surface 228 being hydrophobic is configured to facilitate the water that condenses on condensation surface 228 being flung or projected off of condensation surface 228 when condensation surface 228 is rotated on rotating shaft 204. This may facilitate water condensation device 200 being utilized as a sprinkler. Alternatively, condensation surface 228 may be treated with lasers and/or chemicals, such that condensation surface 228 has a surface texture that is hydrophilic. In such examples, the hydrophilic surfaces may facilitate increased water condensation on the hydrophilic surfaces and retaining condensed water on condensation surface 228.

In some examples, water condensation device 200 comprises a control system including one or more electronic controllers (e.g., motor controller 250 and/or TEC controller 254). For example, water condensation device 200 may include a motor controller 250 that is operatively coupled to electric motor 208 and that is configured to selectively regulate a rotational speed of rotating shaft 204. Motor controller 250 may comprise any suitable device having processing logic that is configured to receive and analyze one or more input values and determine one or more corresponding control operations for controlling the rotational speed of rotating shaft 204, and therefore the rotational speed of condensation member 212 mounted on rotating shaft 204. In some examples, regulating the rotational speed of rotating shaft 204 adjusts a temperature of condensation member 212. For example, increasing the rotational speed of rotating shaft 204 may decrease the surface temperature of condensation member 212 by increasing heat dissipation by heat-sink fan 217 and decreasing rotational speed may increase surface temperature of condensation member 212 by decreasing heat dissipation by heat-sink fan 217.

In some examples, water condensation device 200 comprises any suitable TEC controller 254 that is configured to selectively control the temperature of cold plate 222 of thermoelectric cooling module 214 by regulating the electrical power supplied to thermoelectric cooling module 214 by the battery or other suitable electrical power source. For example, increasing the electrical power supplied to thermoelectric cooling module 214 increases the amount of heat that is actively transferred and/or pumped by thermoelectric cooling module 214 from cold plate 222 to hot plate 220 and therefore decreases the temperature of cold plate 222. In some examples, TEC controller 254 is configured to selectively control the temperature of cold plate 222 in order to maintain condensation member 212 at a desired temperature.

In some examples, motor controller 250 is configured to selectively regulate the rotational speed of condensation core 202 mounted on rotating shaft 204 and/or TEC controller(s) 254 are configured to selectively control TEC module(s) 214 in order to maintain the surface temperature of condensation member 212 at a desired surface temperature. The control system may be configured to selectively regulate the surface temperature of condensation member 212 by only controlling the rotational speed of rotating shaft 204, only controlling TEC module(s) 214, or the surface temperature may be controlled by controlling both the rotational speed of rotating shaft 204 and the amount of electrical power supplied to TEC module(s) 214.

The control system of water condensation device 200 including motor controller 250 and/or TEC controller(s) 254 may be configured to cool condensation member 212 to any suitable surface temperature and/or maintain condensation member 212 at any suitable surface temperature configured to promote condensation of water vapor on the surfaces of condensation member 212. In some examples, processing logic of the control system is configured to dynamically determine the surface temperature at which to maintain condensation member 212 based on the ambient environmental conditions (e.g., relative humidity, dew point temperature, air temperature, etc.) and/or current operating conditions (e.g., temperature) of one or more of the components of condensation core 202 detected by one or more sensor(s) 252 of water condensation device 200. For example, the surface temperature of condensation member 212 may be maintained at or below the ambient dew point temperature. Alternatively, in some examples, the control system may be configured to cool and maintain condensation member 212 at a predetermined set point temperature, e.g., approximately 0 degrees Celsius.

Water condensation device 200 may comprise any suitable sensors 252 (e.g., temperature sensors, humidity sensors, etc.) configured to detect the temperature of condensation member 212, the temperature of cold plate 222, the temperature of the surrounding environment, the relative humidity and/or dew point of the surrounding environment, and/or any other suitable data relating to the condition of one or more component(s) of condensation core 202 and/or the surrounding environment. For example, sensor(s) 252 may include an RTC thermistor and/or any other suitable temperature sensor(s) configured to detect the temperature of condensation member 212 and/or cold plate 222 of thermoelectric cooling module 214.

In some examples, the control system of water condensation device 200 is configured to operate substantially similarly to the control system of condensation core 2 and/or water condensation device 100, discussed above. For example, the control system of water condensation device 200 may include processing logic and/or one or more algorithms configured to attempt to maximize the amount of water produced by condensation core 202 per amount of energy used. Explained in other words, the control system may be configured to dynamically control the electrical power provided to TEC module(s) 214 and/or electric motor 208 to maintain condensation member 212 at a temperature that promotes water condensation, without exceeding the point where additional power input results in diminished cooling performance provided by TEC module(s) 214.

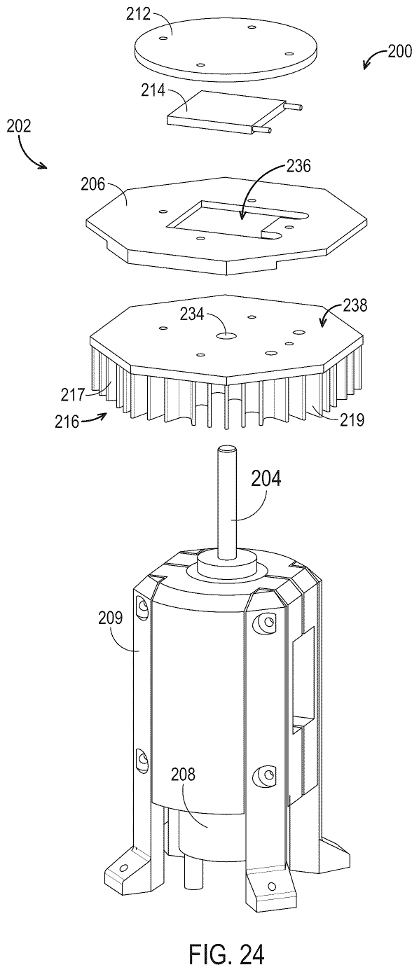

FIGS. 23-24 illustrate a non-limiting example of water condensation device 200 shown schematically in FIG. 22. As shown in FIG. 23, example water condensation device 200 includes an electric motor 208 supported by a motor housing 209. Electric motor 208 is configured to selectively rotate a shaft 204. Water condensation device 200 includes condensation core 202 coaxially mounted on shaft 204, such that condensation core 202 is configured to be selectively rotated by electric motor 208.

As shown in FIG. 24 illustrating an exploded view of condensation core 202, condensation core 202 includes a heat sink 216 comprising a heat-sink fan 217, a mounting plate 206, a thermoelectric cooling module 214, and a condensation member 212. Heat sink 216 includes a central bore 234 that is configured to receive shaft 204 to operatively couple heat sink 216 to shaft 204. Mounting plate 206 is configured to be coupled to an upper surface 238 of heat sink 216 using any suitable fastener(s). Mounting plate 206 defines an opening 236 shaped to receive thermoelectric cooling module 214. In some examples, thermoelectric cooling module 214 is received in opening 236 and rests on upper surface 238 of heat sink 216. Condensation member 212 is coupled to the upper side of mounting plate 206, such that thermoelectric cooling module 214 is sandwiched between heat sink 216 and condensation member 212 and disposed within opening 236 of mounting plate 206.

### D. Illustrative Water Condensation Method

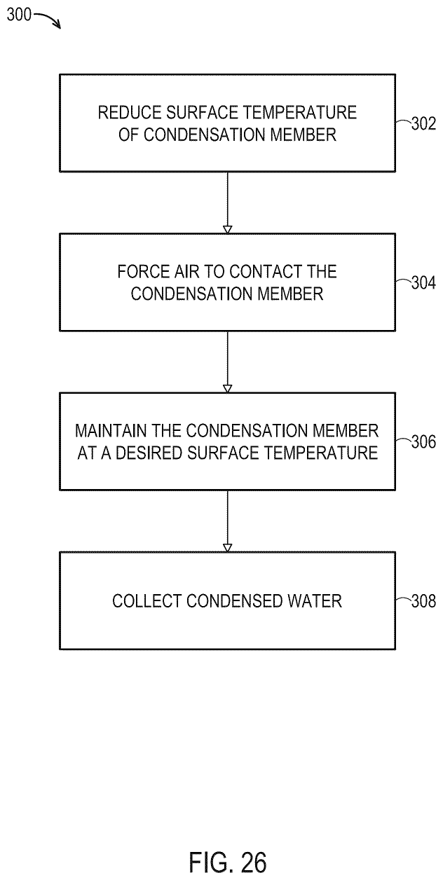

This section describes steps of an illustrative method 300 for producing water using a water condensation device; see FIG. 26. Aspects of solid-state condensation core 2 and water condensation devices 100 and 200 may be utilized in the method steps described below. Where appropriate, reference may be made to components and systems that may be used in carrying out each step. These references are for illustration, and are not intended to limit the possible ways of carrying out any particular step of the method.

FIG. 26 is a flowchart illustrating steps performed in an illustrative method, and may not recite the complete process or all steps of the method. Although various steps of method 300 are described below and depicted in FIG. 26, the steps need not necessarily all be performed, and in some cases may be performed simultaneously or in a different order than the order shown.

Step 302 of method 300 includes reducing a surface temperature of a condensation member of the water condensation device. In some examples, the condensation member 112, 212 comprises a condensation prism 132 or a metal plate 232, as described above. In some examples, a thermoelectric cooling module (e.g., thermoelectric cooling module 114, 214) is utilized to reduce the surface temperature of the condensation member. For example, as described above, the cold plate(s) of one or more thermoelectric cooling modules may be placed in contact with the condensation member in order to absorb heat from the condensation member. The surface temperature of the condensation member is reduced to any suitable temperature configured to induce condensation of the water vapor in the air that contacts the condensation member.

Step 304 of method 300 includes forcing air to contact and/or pass over the condensation member. In some examples, an intake fan (e.g., intake fan 104) is utilized to draw in air from a surrounding environment and force the air to pass over or against the condensation member having the reduced surface temperature. In some examples, the condensation member itself is configured to be rotated and exposed to air in an external environment, such that the air passes over and contacts the condensation member as the condensation member is rotated. For example, the condensation member may be mounted on a rotating shaft of an electrical motor, as described above with respect to water condensation device 200. When the air passes over the condensation member having the reduced surface temperature, the air is cooled below its dew point and water vapor in the air condenses onto the condensation surface.

Step 306 of method 300 includes maintaining the surface temperature of the condensation member at a desired temperature. The desired temperature of the condensation member may be any suitable surface temperature configured to induce condensation of water vapor on the surfaces of the condensation member. The surface temperature of the condensation member may be controlled and maintained at the desired temperature by regulating an air intake fan speed, regulating a rotational speed of the condensation member itself (e.g., when condensation member is mounted on a rotating shaft), controlling the thermoelectric cooling module(s), and/or controlling heat sink(s) of the device.

In some examples, the surface temperature of the condensation member is controlled by selectively regulating a speed of the air passing over the condensation member, e.g., by regulating a fan speed of an intake fan. For example, if an intake fan is utilized in step 304 to force air against the condensation member, the fan speed of the intake fan may be adjusted to adjust the surface temperature of the condensation member. Increasing the fan speed increases the surface temperature and decreasing the fan speed decreases the surface temperature. In some examples, a controller (e.g., controller 150, 250) is configured to selectively regulate the fan speed of the intake fan in order to maintain the desired surface temperature of the condensation member. In some examples, a temperature sensor (e.g., an RTC thermistor) may be utilized to detect the current surface temperature of the condensation member and/or the current temperature of the cold plate of the thermoelectric cooling module in contact with the condensation member. The controller may selectively regulate the fan speed based on the detected temperature.

In some examples, a TEC controller is utilized to control the temperature of the cold plate of the thermoelectric cooling module by regulating the electrical power supplied to the thermoelectric cooling module. By adjusting the temperature of the cold plate, the TEC controller is configured to selectively adjust the surface temperature of the condensation member that is in contact with the cold plate. In such examples, the TEC controller may adjust the electrical power supplied to the thermoelectric cooling module based on the detected temperature in order to achieve the desired surface temperature of the condensation member.

In some examples, the surface temperature of the condensation member is controlled by regulating heat dissipation by the heat sink(s) configured to dissipate heat from the thermoelectric cooling module. For example, an electronic controller may be utilized to regulate heat dissipation by the heat sink(s) of the water condensation device and increasing heat dissipation by the heat sink(s) may increase the amount of heat that is transferred from the cold plate to the hot plate of the thermoelectric cooling module. Increasing the amount of heat that is transferred from the cold plate to the hot plate may decrease the temperature of the cold plate and therefore decrease the surface temperature of the condensation member. In some examples, increasing heat dissipation by the heat sink(s) (e.g., by increasing a heat-sink fan speed) decreases the surface temperature of the condensation member and decreasing heat dissipation by the heat sink(s) increases the surface temperature of the condensation member.

In some examples, the condensation member, the thermoelectric cooling module, and a heat-sink fan are mounted on the shaft of an electrical motor, such that the electric motor is configured to rotate the condensation member, thermoelectric cooling module, and heat-sink fan together on the shaft. In such examples, increasing the rotational speed of the shaft may increase the rotational speed of the heat-sink fan, which may increase heat dissipation by the heat-sink fan. In such examples, the surface temperature of the condensation member may be controlled by adjusting the rotational speed of the shaft. For example, increasing the rotational speed of the shaft increases heat dissipation by the heat-sink fan and decreases the surface temperature of the condensation member and decreasing the rotational speed decreases heat dissipation by the heat-sink fan and increases the surface temperature of the condensation member.

In some examples, processing logic of the water condensation device is configured to dynamically determine and/or calculate the desired surface temperature of the condensation member based on one or more ambient environmental condition(s) (e.g., relative humidity, dew point, air temperature, etc.) and/or based on the condition (e.g., temperature) of the components of the water condensation device. For example, the desired surface temperature of the condensation member may be set at or below the ambient dew point temperature. Alternatively, and/or additionally, in some examples, the control system is configured to maintain condensation member at any suitable predetermined surface temperature (e.g., 0-degrees Celsius).

Step 308 of method 300 includes collecting water that condenses on the condensation member. In some examples, a water collector, such as a water bottle, is positioned proximate the condensation member in order to receive the water that condenses on the condensation member. In some examples, as described above, surfaces of the condensation member are hydrophobic in order to prevent the condensed water from becoming stuck or trapped on the condensation member. In some examples, the water collector is positioned beneath the condensation member to facilitate gravity forcing the condensed water off of the condensation member and into the water collector.

Alternatively, in some examples, rather than collecting the water in a water collector, the water may be dispersed away from the condensation member during use. For example, if the condensation member is mounted on the rotating shaft of an electric motor, the condensed water may be thrown or projected outward off of the condensation member when the condensation member is rotated on rotating shaft. In such examples, the condensation device including the condensation member may function similarly to a sprinkler.

### E. Illustrative Combinations and Additional Examples

This section describes additional aspects and features of water condensation devices, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.
A0. A water condensation device, comprising:
a condensation core, comprising:
   a thermoelectric module comprising a cold surface and a hot surface, wherein the thermoelectric module is configured to actively transfer heat from the cold surface to the hot surface;
   a condensation member in contact with the cold surface, wherein the thermoelectric module is configured to reduce a surface temperature of the condensation member; and
   a heat sink operatively coupled to the hot surface and configured to dissipate heat from the thermoelectric module.
B0. The water condensation device of paragraph A0, wherein the condensation core is operatively coupled to a shaft of an electric motor, wherein the electric motor is configured to selectively rotate the shaft.
B1. The water condensation device of paragraph A1, wherein rotating the shaft causes air to pass over the condensation member.
B2. The water condensation device of paragraph B0 or B1, further comprising a controller operatively coupled to the electric motor to selectively regulate a rotational speed of the shaft.
B2.1. The water condensation device of any one of paragraphs B1, wherein rotating the shaft causes air to pass over the condensation member.
B2.2. The water condensation device of any one of paragraphs B2 or B2.1, wherein the heat sink comprises a heat-sink fan including a plurality of fins, wherein rotating the shaft causes the heat-sink fan to rotate.
B2.3. The water condensation device of paragraph B2.2, wherein increasing a rotational speed of the shaft increases heat dissipation by the heat-sink fan, and wherein decreasing the rotational speed of the shaft decreases heat dissipation by the heat sink-fan.
B3. The water condensation device of any one of paragraphs B0-B2.3, wherein the condensation core is configured to be oriented, such that the water condensation member is disposed vertically below the thermoelectric module and the heat sink, during use.
B4. The water condensation device of any one of paragraphs B0-B3, wherein the condensation member includes a planar condensation surface.
B5. The water condensation device of any one of paragraphs B0-B4, wherein the condensation member comprises a thermally conductive material.
B6. The water condensation device of any one of paragraphs B0-B5, wherein the condensation member comprises aluminum.
B7. The water condensation device of any one of paragraphs B0-B6, further comprising a thermoelectric-module controller configured to regulate a temperature of the cold surface by selectively controlling electrical power supplied to the thermoelectric module.
B7.1. The water condensation device of paragraph B7, further comprising a electrical power source electrically coupled to the thermoelectric module, wherein the thermoelectric-module controller is configured to selectively regulate electrical power supplied to the thermoelectric module by the electrical power source.
B7.2. The water condensation device of paragraph B7 or B7.1, further comprising one or more sensors, wherein the thermoelectric-module controller is configured to selectively control the electrical power supplied to the thermoelectric module based on data detected by the one or more sensors.
B7.3. The water condensation device of paragraph B7.2, wherein the one or more sensors include a temperature sensor configured to detect the surface temperature of the condensation member, and wherein the thermoelectric-module controller is configured to selectively control the electrical power supplied to the thermoelectric module to maintain the surface temperature of the condensation member at a desired surface temperature.
B7.4. The water condensation device of paragraph B7.2 or B7.3, wherein the one or more sensors include at least one sensor configured to detect ambient environmental conditions.
B7.5. The water condensation device of paragraph B7.4, wherein the ambient environmental conditions include a dew point temperature and/or a relative humidity in the surrounding environment.
B7.6. The water condensation device of any one of paragraphs B7.1-B7.5, wherein the electrical power source comprises a battery.
B7.7. The water condensation device of paragraph B7.6, wherein the battery comprises a rechargeable battery.
B8. The water condensation device of any one of paragraphs B0-B7.7, wherein the thermoelectric module includes a plurality of semiconductors separating the cold surface from the hot surface, wherein the thermoelectric module is configured to actively transfer the heat from the cold surface to the hot surface through the plurality of semiconductors.
B8.1. The water condensation device of paragraph B8, wherein the plurality of semiconductors comprise a plurality of alternating p-type semiconductors and n-type semiconductors connected electrically in series with each other and a/the electrical power source.
B9. The water condensation device of any one of paragraphs B0-B8.1, wherein the condensation member comprises a planar cooling surface in contact with the cold surface.
B10. The water condensation device of any one of paragraphs B0-B9, wherein the cold surface and the hot surface each comprise a thermally conductive plate.
B11. The water condensation device of any one of paragraphs B0-B10, wherein the cold surface and the hot surface each comprise a ceramic plate.
B12. The water condensation device of any one of paragraphs B0-B11, wherein the condensation member comprises one or more surfaces having a specific surface wettability.
B12.1. The water condensation device of paragraph B12, wherein the one or more surfaces are textured.
B12.2. The water condensation device of paragraph B12 or B12.1, wherein the one or more surfaces are textured using chemicals and/or a laser treatment.
B12.3. The water condensation device of any one of paragraphs B12-B12.2, wherein the one or more surfaces are hydrophobic.
B12.4. The water condensation device of any one of paragraphs B12-B12.2, wherein the one or more surfaces are hydrophilic.
B13. The water condensation device of any one of paragraphs B0-B12.4, wherein the thermoelectric module comprises a thermoelectric cooling (TEC) module.
B14. The water condensation device of any one of paragraphs B0-B13, further comprising a/the electrical power source configured to provide electrical power to the thermoelectric module and/or the heat sink.
C0. The water condensation device of paragraph A0, wherein the water condensation member comprises a condensation prism.
C1. The water condensation device of paragraph C0, wherein the condensation prism defines an airflow channel extending through the condensation prism along an airflow axis, wherein the airflow channel has an inlet and an outlet.
C1.1. The water condensation device of paragraph C1, wherein the condensation prism comprises one or more deflection structures disposed within the airflow channel, wherein the one or more deflection structures are configured to deflect and obstruct air moving through the airflow channel from the inlet to the outlet.
C1.2. The water condensation device of paragraph C1.1, wherein the one or more deflection structures comprise a plurality of pegs extending across the airflow channel.
C1.3. The water condensation device of paragraph C1.2, wherein the plurality of pegs are arranged in offset rows along the airflow axis of the airflow channel.
C1.4. The water condensation device of any one of paragraphs C1.1-C1.3, wherein the plurality of deflection structures are V-shaped and extend across the airflow channel.
C1.5. The water condensation device of any one of paragraphs C1-C1.4, wherein the inlet and the outlet are formed in opposing sides of the condensation prism.
C2. The water condensation device of any one of paragraphs C0-C1.5, further comprising:
an intake fan configured to draw in air from a surrounding environment and cause the air to pass through the inlet of the airflow channel.
C2.1. The water condensation device of paragraph C2, further comprising a controller configured to control a fan speed of the intake fan to regulate a speed of the air passing through the inlet.
C2.2. The water condensation device of paragraph C2.1, further comprising a temperature sensor configured to detect a measured surface temperature of the condensation prism, wherein the controller is configured to selectively regulate the fan speed based on the measured surface temperature.
C2.3. The water condensation device of paragraph C2.2, wherein the controller is configured to control the fan speed to maintain the surface temperature at a desired surface temperature.
C2.4. The water condensation device of paragraph C2.3, further comprising one or more sensors configured to detect ambient environmental conditions, wherein the controller includes processing logic configured to determine the desired surface temperature based on the detected ambient environmental conditions.
C2.5. The water condensation device of paragraph C2.4, wherein the detected ambient environmental conditions include a dew point temperature and/or a relative humidity.
C2.6. The water condensation device of any one of paragraphs C2.3-C2.5, wherein in response to the measured surface temperature being above the desired surface temperature, the controller is configured to decrease the fan speed, and in response to the measured surface temperature being below the desired surface temperature, the controller is configured to increase the fan speed.
C2.7. The water condensation device of paragraph C2.6, wherein increasing the fan speed is configured to increase the surface temperature and decreasing the fan speed is configured to decrease the surface temperature.
C3. The water condensation device of any one of paragraphs C0-C2.7, wherein the condensation prism comprises a first planar cooling surface in contact with the cold surface of the thermoelectric module.
C4. The water condensation device of any one of paragraphs C0-C3, further comprising a second thermoelectric module comprising a second cold surface and a second hot surface, wherein the second cold surface is in contact with the condensation prism.
C4.1. The water condensation device of paragraph C4, further comprising a second heat sink coupled to the second hot surface, wherein the second heat sink is configured to dissipate heat from the second thermoelectric module.
C5. The water condensation device of any one of paragraphs C0-C4.1, further comprising a housing supporting the condensation core.
C5.1. The water condensation device of paragraph C5, wherein the housing comprises a water-receiver connector configured to be operatively coupled to a water receiver to permit the water receiver to collect water that exits the condensation prism through the outlet.
C5.2. The water condensation device of paragraph C5.1, wherein the water-receiver connector comprises a threaded connector.
C6. The water condensation device of any one of paragraphs C0-C5.2, wherein one or more surfaces of the condensation prism are hydrophobic.
C7. The water condensation device of any one of paragraphs C0-C5.2, wherein one or more surfaces of the condensation prism are hydrophilic.
C8. The water condensation device of any one of paragraphs C0-C7, wherein the heat sink comprises a heat-sink fan.
C9. The water condensation device of any one of paragraphs C0-C8, further comprising a thermoelectric-module controller configured to regulate a temperature of the cold surface by selectively controlling electrical power supplied to the thermoelectric module.
C9.1. The water condensation device of paragraph C9, further comprising an electrical power source operatively coupled to the thermoelectric module, wherein the thermoelectric-module controller is configured to selectively regulate the electrical power supplied to the thermoelectric module by the electrical power source.
C9.2. The water condensation device of paragraph C9 or C9.1, further comprising one or more sensors, wherein the thermoelectric-module controller is configured to selectively control the electrical power supplied to the thermoelectric module based on data detected by the one or more sensors.
C9.3. The water condensation device of paragraph C9.2, wherein the one or more sensors include a/the temperature sensor configured to detect the surface temperature of the condensation member, and wherein the thermoelectric-module controller is configured to selectively control the electrical power supplied to the thermoelectric module to maintain the surface temperature of the condensation member at a desired surface temperature.
C9.4. The water condensation device of paragraph C9.2 or C9.3, wherein the one or more sensors include at least one sensor configured to detect ambient environmental conditions.
C9.5. The water condensation device of paragraph C9.4, wherein the ambient environmental conditions include a dew point temperature and/or a relative humidity.
C9.6. The water condensation device of any one of paragraphs C9.1-C9.5, wherein the electrical power sources comprises a battery.
C9.7. The water condensation device of paragraph C9.6, wherein the battery comprises a rechargeable battery.
C10. The water condensation device of any one of paragraphs C0-C9.7, wherein the thermoelectric module includes a plurality of semiconductors separating the cold surface from the hot surface, wherein the thermoelectric module is configured to actively transfer the heat from the cold surface to the hot surface through the plurality of semiconductors.
C10.1. The water condensation device of paragraph C10, wherein the plurality of semiconductors comprise a plurality of alternating p-type semiconductors and n-type semiconductors connected electrically in series with each other and a/the electrical power source.
C11. The water condensation device of any one of paragraphs C0-C10, wherein the condensation prism comprises a chevron prism, wherein the chevron prism includes a plurality of V-shaped deflection structures extending across the airflow channel, and wherein the plurality of V-shaped deflection structures form a V-shaped inlet and a V-shaped outlet of the airflow channel.
C11.1. The water condensation device of paragraph C11, wherein the chevron prism comprises a plurality of chevron plates, wherein each chevron plate includes a plurality of the V-shaped deflection structures and a plurality of V-shaped slots formed between the plurality of V-shaped deflection structures of the chevron plate.
C11.2. The water condensation device of paragraph C11.1, wherein the plurality of chevron plates are operatively coupled to each other to form the chevron prism.
C11.3. The water condensation device of any one of paragraphs C11-C11.2, wherein each chevron plate comprises an aluminum metal plate defining the plurality of V-shaped slots.
C11.4. The water condensation device of any one of paragraphs C11.1-C11.3, wherein the cold surface directly contacts one or more of the plurality of chevron plates.
C11.5. The water condensation device of any one of paragraphs C11-C11.4, further comprising a pair of planar end plates disposed on opposing ends of the chevron prism.
C12. The water condensation device of any one of paragraphs C0-C11.5, wherein the cold surface and the hot surface each comprise a thermally conductive plate.
C13. The water condensation device of any one of paragraphs C0-C12, wherein the cold surface and the hot surface each comprise a ceramic plate.
C14. The water condensation device of any one of paragraphs C0-C13, wherein the thermoelectric module comprises a thermoelectric cooling (TEC) module.
C15. The water condensation device of any one of paragraphs C0-C14, wherein the condensation prism is formed as a single piece.
C16. The water condensation device of any one of paragraphs C0-C14, wherein the condensation prism includes multiple parts fixed to each other, such that the multiple parts are inseparable other than by using destructive methods.
C17. The water condensation device of any one of paragraphs C0-C16, further comprising a/the electrical power source configured to provide electrical power to the thermoelectric module and/or the heat sink.
D0. A water condensation device, comprising:
a condensation prism defining an airflow channel extending through the condensation prism along an airflow axis, wherein the airflow channel has an inlet and an outlet;
a thermoelectric cooling module (TEC) comprising a cold plate and a hot plate, wherein the cold plate is in contact with the condensation prism, and wherein the thermoelectric cooling module is configured to actively transfer heat from the cold plate to the hot plate to reduce a surface temperature of the condensation prism;
a heat sink operatively coupled to the hot plate, wherein the heat sink is configured to dissipate heat from the thermoelectric cooling module; and
an intake fan configured to draw in air from a surrounding environment and cause the air to pass through the inlet of the airflow channel.
D1. The water condensation device of paragraph D0, wherein the condensation prism comprises one or more deflection structures disposed within the airflow channel, and wherein the one or more deflection structures are configured to deflect air moving through the airflow channel.
D1.1. The water condensation device of paragraph D1, wherein the one or more deflection structures comprise a plurality of pegs extending across the airflow channel transverse to the airflow axis.
D1.2. The water condensation device of paragraph D1.1, wherein the plurality of pegs are arranged in offset rows along the airflow axis.
D2. The water condensation device of any one of paragraphs D-D1.2, wherein the condensation prism further comprises a planar cooling surface in contact with the cold plate.
D3. The water condensation device of any one of paragraphs D-D2, wherein the condensation prism comprises a thermally conductive material.
D3.1. The water condensation device of paragraph D3, wherein the condensation prism comprises aluminum.
D4. The water condensation device of any one of paragraphs D-D3.1, wherein one or more surfaces of the condensation prism have a specific surface wettability.
D4.1. The water condensation device of paragraph D4, wherein the one or more surfaces are treated utilizing one or more of lasers and chemicals.
D4.2. The water condensation device of paragraph D4 or D4.1, wherein the one or more surfaces are hydrophobic.
D4.3. The water condensation device of paragraph D4 or D4.1, wherein the one or more surfaces are hydrophilic.
D5. The water condensation device of any one of paragraphs D-D4.3, further comprising a controller operatively coupled to the intake fan and configured to control a fan speed of the intake fan to regulate a speed of the air passing through the inlet.
D5.1. The water condensation device of paragraph D5, further comprising a temperature sensor configured to detect a measured surface temperature of the condensation prism, wherein the controller is configured to selectively regulate the fan speed based on the measured surface temperature.
D5.2. The water condensation device of paragraph D5.1, wherein the controller is configured to control the fan speed to maintain the surface temperature at a desired surface temperature.
D5.3. The water condensation device of paragraph D5.2, further comprising at least one sensor configured to detect ambient environmental conditions, wherein the controller includes processing logic configured to determine the desired surface temperature based on the detected ambient environmental conditions.
D5.4. The water condensation device of paragraph D5.3, wherein the detected ambient environmental conditions include a dew point temperature and/or a relative humidity.
D5.5. The water condensation device of any one of paragraphs D5.2-D5.4, wherein in response to the measured surface temperature being greater than the desired surface temperature, the controller is configured to decrease the fan speed, and in response to the measured surface temperature being less than the desired surface temperature, the controller is configured to increase the fan speed.
D5.6. The water condensation device of paragraph D5.5, wherein increasing the fan speed is configured to increase the surface temperature and decreasing the fan speed is configured to decrease the surface temperature.
D6. The water condensation device of any one of paragraphs D0-D5.6, wherein the condensation prism comprises a first planar cooling surface in contact with the cold plate of the thermoelectric cooling module.
D7. The water condensation device of any one of paragraphs D0-D6, further comprising a second thermoelectric cooling (TEC) module comprising a second cold plate and a second hot plate, wherein the condensation prism has a second planar cooling surface in contact with the second cold plate.
D7.1. The water condensation device of paragraph D7, further comprising a second heat sink operatively coupled to the second hot plate, wherein the second heat sink is configured to dissipate heat from the second thermoelectric cooling module.
D8. The water condensation device of any one of paragraphs D0-D8, further comprising a housing supporting the condensation core.
D8.1. The water condensation device of paragraph D8, wherein the housing comprises a water-receiver connector configured to be operatively coupled to a water receiver, wherein the water receiver is configured to collect water that drains from the outlet.
D8.2. The water condensation device of paragraph D8.1, wherein the water receiver connector comprises a threaded connector.
D9. The water condensation device of any one of paragraphs D0-D8.2, wherein the heat sink comprises a heat-sink fan.
D10. The water condensation device of any one of paragraphs D0-D8.2, wherein the heat sink comprises a thermally conductive water-cooling block.
D11. The water condensation device of any one of paragraphs D0-D10, wherein the condensation prism comprises a chevron prism, wherein the chevron prism includes a plurality of V-shaped deflection structures extending across the airflow channel, and wherein the plurality of V-shaped deflection structures form a V-shaped inlet and a V-shaped outlet of the airflow channel.
D11.1. The water condensation device of paragraph D11, wherein the chevron prism comprises a plurality of chevron plates, wherein each chevron plate includes a plurality of the V-shaped deflection structures and a plurality of V-shaped slots formed between the plurality of V-shaped deflection structures of the chevron plate.
D11.2. The water condensation device of paragraph D11.1, wherein the plurality of chevron plates are operatively coupled to each other to form the chevron prism.
D11.3. The water condensation device of any one of paragraphs D11-D11.2, wherein each chevron plate comprises an aluminum metal plate defining the plurality of V-shaped slots.
D11.4. The water condensation device of any one of paragraphs D11.1-D11.3, wherein the cold plate directly contacts one or more of the plurality of chevron plates.
D11.5. The water condensation device of any one of paragraphs D11-D11.4, further comprising a pair of planar end plates disposed on opposing ends of the chevron prism.
D12. The water condensation device of any one of paragraphs D0-D11.5, further comprising a/the electrical power source configured to provide electrical power to the thermoelectric module and/or the heat sink.
E0. A water condensation device, comprising:
a condensation core, comprising:
   a thermoelectric cooling module comprising a cold plate and a hot plate, wherein the thermoelectric cooling module is configured to actively transfer heat from the cold plate to the hot plate;
   a condensation member in direct contact with the cold plate, wherein the thermoelectric cooling module is configured to draw heat away from the condensation member to reduce a surface temperature of the condensation member; and
   a heat sink operatively coupled to the hot plate, wherein the heat sink is configured to dissipate heat from the thermoelectric cooling module; and
an electric motor, wherein the condensation core is operatively coupled to the electric motor, such that the electric motor is configured to selectively rotate the condensation core.
E1. The water condensation device of paragraph E0, further comprising the features and/or components of the water condensation device of any one of paragraphs B0-B14.
F0. A method for generating water using a water condensation device, the method comprising:
reducing a surface temperature of a condensation member of the condensation device utilizing a thermoelectric module; and
causing air to pass over the condensation member.
F1. The method of paragraph F0, wherein causing air to pass over the condensation member comprises drawing in air from a surrounding environment using an intake fan.
F1.1. The method of paragraph F1, wherein the water condensation device comprises the water condensation device of any one of paragraphs C0-C17.
F1.2. The method of paragraph F1 or F1.1, wherein the condensation member comprises a condensation prism defining a tortuous airflow pathway obstructed by a plurality of deflection structures, wherein causing air to pass over the condensation member comprises causing air to pass through the tortuous airflow pathway.
F2. The method of paragraph F0, wherein causing air to pass over the condensation member comprises rotating the condensation member on a rotating shaft of an electric motor.
F2.1. The method of paragraph F2, wherein the water condensation device comprises the water condensation device of any one of paragraphs B0-B14.
F3. The method of any one of paragraphs F0-F2.1, further comprising maintaining the surface temperature of the condensation member at a desired surface temperature.
F3.1. The method of paragraph F3 when depending from paragraph F1-F1.2, wherein maintaining the surface temperature of the condensation member at the desired surface temperature comprises regulating a fan speed of the intake fan.
F3.2. The method of paragraph F3.1, wherein increasing the fan speed increases the surface temperature of the condensation member and decreasing the fan speed decreases the surface temperature of the condensation member.
F3.3. The method of paragraph F3 when depending from paragraph F2 or F2.1, further comprising a heat-sink fan mounted on the rotating shaft, wherein maintaining the surface temperature of the condensation member at the desired surface temperature comprises adjusting a rotational speed of the rotating shaft to adjust heat dissipation by the heat-sink fan.
F3.4. The method of any one of paragraphs F3-F3.3, wherein maintaining the surface temperature of the condensation member at the desired surface temperature comprises regulating electrical power supplied to the thermoelectric module by an electrical power source.
F4. The method of any one of paragraphs F0-F3.4, further comprising collecting water that condenses on the condensation member in a water collector.
G0. A solid-state condensation core, comprising:
a thermoelectric cooling (TEC) module comprising a cold plate and a hot plate separated by a plurality of semiconductors, wherein the thermoelectric cooling module is configured to transfer heat from the cold plate to the hot plate through the plurality of semiconductors;
a condensation member in contact with the cold plate, wherein the thermoelectric cooling module is configured to draw heat away from the condensation member to reduce a surface temperature of the condensation member; and
a heat sink operatively coupled to the hot plate, wherein the heat sink is configured to dissipate heat from the hot plate.
G1. The solid-state condensation core of paragraph G0, further comprising the features and/or components of any one paragraphs B0-B14 or C0-C17.
H0. A solid-state condensation core, comprising:
a solid-state cooling device;
a condensation member operatively coupled to the solid-state cooling device, such that the solid-state cooling device is configured to reduce a surface temperature of the condensation member; and
a heat sink operatively coupled to the solid-state cooling device, such that the heat sink is configured to dissipate heat from the solid-state cooling device.
H0. The solid-state condensation core of paragraph H0, further comprising the features and/or components of any one paragraphs B0-B14 or C0-C17.
I0. A water condensation device, comprising:
a condensation core, comprising:
   a thermoelectric module comprising a cold surface and a hot surface, wherein the thermoelectric module is configured to actively transfer heat from the cold surface to the hot surface;
   a condensation member in contact with the cold surface, wherein the thermoelectric module is configured to reduce a surface temperature of the condensation member; and
   a heat sink operatively coupled to the hot surface and configured to dissipate heat from the hot surface.
I1. The water condensation device of paragraph I0, further comprising an electric motor including a shaft configured to be selectively rotated by the electric motor, wherein the condensation core is operatively coupled to the shaft, and wherein rotating the shaft causes air to pass over the condensation member.
I1.1. The water condensation device of paragraph I1, wherein the heat sink comprises a heat-sink fan including a plurality of fins, wherein rotating the shaft causes the plurality of fins to rotate.
I1.2. The water condensation device of paragraph I1 or I1.1, wherein the condensation core is configured to be oriented, such that the condensation member is disposed vertically below the thermoelectric module and the heat sink, during use.
I1.3. The water condensation device of any one of paragraphs I1-I1.2, wherein the condensation member comprises a thermally conductive metal plate.
I2. The water condensation device of paragraph I0, wherein the condensation member comprises a condensation prism, wherein the condensation prism defines an airflow channel extending through the condensation prism along an airflow axis, wherein the airflow channel has an inlet and an outlet.
I2.1. The water condensation device of paragraph I2, wherein the condensation prism comprises one or more deflection structures disposed within the airflow channel, wherein the one or more deflection structures are configured to deflect and obstruct air moving through the airflow channel from the inlet to the outlet.
I2.2. The water condensation device of paragraph I2.1, wherein the one or more deflection structures comprise a plurality of pegs extending across the airflow channel.
I2.3. The water condensation device of any one of paragraphs I2-I2.2, further comprising:
an intake fan configured to draw in air from a surrounding environment and cause the air to pass through the inlet of the airflow channel.
I2.4. The water condensation device of paragraph I2.3, further comprising a controller configured to control a fan speed of the intake fan, wherein the controller is configured to selectively control the fan speed to maintain the surface temperature of the condensation prism at a desired surface temperature.
I2.5. The water condensation device of any one of paragraphs I2-I2.4, wherein the condensation prism comprises a chevron prism, wherein the chevron prism includes a plurality of V-shaped deflection structures extending across the airflow channel, and wherein the plurality of V-shaped deflection structures form a V-shaped inlet and a V-shaped outlet of the airflow channel.
I3. The water condensation device of any one of paragraphs I0-I2.5, further comprising a thermoelectric-module controller and an electrical power source operatively coupled to the thermoelectric module, wherein the thermoelectric-module controller is configured to control a temperature of the cold surface by selectively regulating electrical power supplied to the thermoelectric module by the electrical power source.
I3.1. The water condensation device of paragraph I3, further comprising a temperature sensor configured to detect the surface temperature of the condensation member, wherein the thermoelectric-module controller is configured to control the temperature of the cold surface to maintain the surface temperature of the condensation member at a desired surface temperature.
I3.2. The water condensation device of paragraph I3 or I3.1, further comprising at least one sensor configured to detect one or more ambient environmental conditions, wherein the thermoelectric-module controller is configured to control the temperature of the cold surface based on the one or more ambient environmental conditions detected by the at least one sensor.
I4. The water condensation device of any one of paragraphs I0-I3.2, wherein the thermoelectric module includes a plurality of semiconductors separating the cold surface from the hot surface, wherein the thermoelectric module is configured to actively transfer the heat from the cold surface to the hot surface through the plurality of semiconductors.
I5. The water condensation device of any one of paragraphs I0-I4, wherein the cold surface comprises a cold plate in direct contact with the condensation member and the hot surface comprises a hot plate operatively coupled to the heat sink.
J0. A method for generating water using a water condensation device, the method comprising:
reducing a surface temperature of a condensation member of the water condensation device utilizing a thermoelectric module; and
causing air to pass over the condensation member.
J1. The method of paragraph J0, wherein the condensation member is operatively coupled to a rotating shaft of an electric motor, and wherein causing air to pass over the condensation member comprises rotating the rotating shaft using the electric motor.
J2. The method of paragraph J0 or J1, wherein the condensation member comprises a condensation prism defining a tortuous airflow pathway obstructed by a plurality of deflection structures, wherein causing air to pass over the condensation member comprises causing air to pass through the tortuous airflow pathway.
J3. The method of any one of paragraphs J0-J2, wherein causing air to pass over the condensation member comprises drawing in air from a surrounding environment using an intake fan.
J4. The method of paragraph J3, further comprising maintaining the surface temperature of the condensation member at a desired surface temperature, wherein maintaining the surface temperature of the condensation member at the desired surface temperature comprises selectively regulating a fan speed of the intake fan.

### Advantages, Features, and Benefits

The different embodiments and examples of the water condensation devices described herein provide several advantages over known solutions. For example, illustrative embodiments and examples described herein include a condensation core, which utilizes a solid-state cooling device, such as a thermoelectric cooling module, to cool a condensation surface in order to induce condensation of water vapor on the condensation surface. Utilizing a solid-state cooling device, such as a thermoelectric cooling (TEC) module, has many benefits and advantages. For example, thermoelectric cooling modules are compact and have a relatively small footprint, which facilitates the water condensation devices disclosed herein being compact and, in some examples, easily portable. Additionally, thermoelectric cooling modules do not require moving parts or liquid coolants. This results in reduced maintenance needs and/or maintenance complexity. Additionally, thermoelectric cooling modules allow for precise control of the surface temperature of the condensation surface.

Additionally, and among other benefits, illustrative embodiments and examples described herein allow multiple methods of causing air to pass over the condensation surfaces of the device in order to induce condensation of water vapor on the condensation surfaces. For example, the water condensation device may include an intake fan, which forces air against the condensation surfaces of the device. Alternatively, or additionally, the water condensation device may include an electric motor that is configured to rotate the condensation surfaces themselves to cause air to pass over and contact the condensation surfaces.

Additionally, and among other benefits, illustrative embodiments and examples described herein allow condensation surfaces of the device to be treated using chemicals and/or lasers, such that the condensation surfaces have a specific surface wettability, e.g., are hydrophobic or hydrophilic. The condensation surfaces being hydrophobic may prevent water that condenses on the condensation surfaces from becoming stuck or trapped in the device during use. The condensation surfaces being hydrophilic may facilitate condensation of water on the condensation surfaces and retaining the condensed water on the hydrophilic surfaces.

Additionally, and among other benefits, illustrative embodiments and examples described herein allow a condensation prism that is configured to efficiently cause condensation of water vapor on surfaces of the condensation prism when the surfaces of the condensation prism are cooled, e.g., by a thermoelectric cooling module. The condensation prism includes a tortuous airflow channel or passageway obstructed by a plurality of deflection surfaces within the airflow channel. The plurality of deflection surfaces are configured to increase turbulence in the air passing through the airflow channel and increase the total surface area of the cooled surfaces of the condensation prism. As such, the condensation prism is configured to increase contact between the air passing through airflow channel and the cooled surfaces of the condensation prism. This increases the cooling effect of the cooled surfaces on the air and increases condensation of water on the cooled surfaces.

Additionally, and among other benefits, illustrative embodiments and examples described herein allow mounting the condensation core on a rotating shaft of an electric motor, such that the condensation core can be rotated at a desired speed during use. Rotating the condensation core causes air to contact condensation surfaces of the condensation core, which induces condensation of water on the condensation surfaces. Additionally, rotating the condensation core causes condensed water on the condensation surfaces to be flung or projected off of the condensation surfaces into the surrounding environment during use. Accordingly, such water condensation devices may be utilized as sprinklers that condense water vapor in the air and project the condensed water outward into the surrounding environment.

No known system or device can perform these functions. However, not all embodiments and examples described herein provide the same advantages or the same degree of advantage.

### Conclusion

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A water condensation device, comprising:
a condensation core, comprising:
a thermoelectric module comprising a cold surface and a hot surface, wherein the thermoelectric module is configured to actively transfer heat from the cold surface to the hot surface;
a condensation member in contact with the cold surface, wherein the thermoelectric module is configured to reduce a surface temperature of the condensation member; and
a heat sink operatively coupled to the hot surface and configured to dissipate heat from the hot surface.

2. The water condensation device of claim 1, further comprising an electric motor including a shaft configured to be selectively rotated by the electric motor, wherein the condensation core is operatively coupled to the shaft, and wherein rotating the shaft causes air to pass over the condensation member.

3. The water condensation device of claim 2, wherein the heat sink comprises a heat-sink fan including a plurality of fins, wherein rotating the shaft causes the plurality of fins to rotate.

4. The water condensation device of claim 2, wherein the condensation core is configured to be oriented, such that the condensation member is disposed vertically below the thermoelectric module and the heat sink, during use.

5. The water condensation device of claim 2, wherein the condensation member comprises a thermally conductive metal plate.

6. The water condensation device of claim 1, wherein the condensation member comprises a condensation prism, wherein the condensation prism defines an airflow channel extending through the condensation prism along an airflow axis, wherein the airflow channel has an inlet and an outlet.

7. The water condensation device of claim 6, wherein the condensation prism comprises one or more deflection structures disposed within the airflow channel, wherein the one or more deflection structures are configured to deflect and obstruct air moving through the airflow channel from the inlet to the outlet.

8. The water condensation device of claim 7, wherein the one or more deflection structures comprise a plurality of pegs extending across the airflow channel.

9. The water condensation device of claim 6, further comprising:
an intake fan configured to draw in air from a surrounding environment and cause the air to pass through the inlet of the airflow channel.

10. The water condensation device of claim 9, further comprising a controller configured to control a fan speed of the intake fan, wherein the controller is configured to selectively control the fan speed to maintain the surface temperature of the condensation prism at a desired surface temperature.

11. The water condensation device of claim 6, wherein the condensation prism comprises a chevron prism, wherein the chevron prism includes a plurality of V-shaped deflection structures extending across the airflow channel, and wherein the plurality of V-shaped deflection structures form a V-shaped inlet and a V-shaped outlet of the airflow channel.

12. The water condensation device of claim 1, further comprising a thermoelectric-module controller and an electrical power source operatively coupled to the thermoelectric module, wherein the thermoelectric-module controller is configured to control a temperature of the cold surface by selectively regulating electrical power supplied to the thermoelectric module by the electrical power source.

13. The water condensation device of claim 12, further comprising at least one sensor configured to detect one or more ambient environmental conditions, wherein the thermoelectric-module controller is configured to control the temperature of the cold surface based on the one or more ambient environmental conditions detected by the at least one sensor.

14. The water condensation device of claim 1, wherein the thermoelectric module includes a plurality of semiconductors separating the cold surface from the hot surface, wherein the thermoelectric module is configured to actively transfer the heat from the cold surface to the hot surface through the plurality of semiconductors.

15. The water condensation device of claim 1, wherein the cold surface comprises a cold plate in direct contact with the condensation member and the hot surface comprises a hot plate operatively coupled to the heat sink.

16. A method for generating water using a water condensation device, the method comprising:
reducing a surface temperature of a condensation member of the water condensation device utilizing a thermoelectric module; and
causing air to pass over the condensation member.

17. The method of claim 16, wherein the condensation member is operatively coupled to a rotating shaft of an electric motor, and wherein causing air to pass over the condensation member comprises rotating the rotating shaft using the electric motor.

18. The method of claim 16, wherein the condensation member comprises a condensation prism defining a tortuous airflow pathway obstructed by a plurality of deflection structures, wherein causing air to pass over the condensation member comprises causing air to pass through the tortuous airflow pathway.

19. The method of claim 16, wherein causing air to pass over the condensation member comprises drawing in air from a surrounding environment using an intake fan.

20. The method of claim 19, further comprising maintaining the surface temperature of the condensation member at a desired surface temperature, wherein maintaining the surface temperature of the condensation member at the desired surface temperature comprises selectively regulating a fan speed of the intake fan.
